(19) United States
(12) Patent Application Publication
(10) Pub. No.: US 2016/0014805 A1
(43) Pub. Date: Jan. 14, 2016

(54) METHODS AND APPARATUS FOR RANGING AND TIMING OFFSET FOR SCHEDULING MULTI-USER UPLINK FRAMES

(71) Applicant: QUALCOMM Incorporated, San Diego, CA (US)

(72) Inventors: Simone Merlin, Solana Beach, CA (US); Hemanth Sampath, San Diego, CA (US)

(21) Appl. No.: 14/794,754

(22) Filed: Jul. 8, 2015

Related U.S. Application Data
(60) Provisional application No. 62/023,105, filed on Jul. 10, 2014.

(51) Int. Cl. H04W 72/12; H04W 56/00

(52) U.S. Cl. CPC H04W 72/1284; H04W 56/0005; H04W 88/08

(57) ABSTRACT

Methods and apparatus for multiple user uplink are provided. In one aspect, a method includes receiving, at an access point, ranging information from a plurality of wireless devices. The method further includes determining a timing adjustment, for each of the plurality of wireless devices, based on the ranging information. The method further includes transmitting a timing adjustment message to each wireless device, the timing adjustment message indicating the timing adjustment. The method further includes transmitting a scheduling message instructing the plurality of wireless devices to transmit uplink data at a first reference time corrected by the timing adjustment.

### PRIORITY CLAIM

This application claims the benefit of U.S. Provisional Application No. 62/023,105, filed Jul. 10, 2014, which is hereby incorporated herein by reference in its entirety.

### FIELD

Certain aspects of the present disclosure generally relate to wireless communications, and more particularly, to methods and apparatus for multiple user uplink communication in a wireless network.

### BACKGROUND

In many telecommunication systems, communications networks are used to exchange messages among several interacting spatially-separated devices. Networks can be classified according to geographic scope, which could be, for example, a metropolitan area, a local area, or a personal area. Such networks can be designated respectively as a wide area network (WAN), metropolitan area network (MAN), local area network (LAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infrared, optical, etc. frequency bands. Wireless networks advantageously facilitate user mobility and rapid field deployment when compared to fixed wired networks.

In order to address the issue of increasing bandwidth requirements that are demanded for wireless communications systems, different schemes are being developed to allow multiple stations (STAs) to communicate with a single access point (AP) by sharing the channel resources while achieving high data throughputs. With limited communication resources, it is desirable to reduce the amount of traffic passing between the access point and the multiple terminals. For example, when multiple terminals send uplink communications to the access point, it is desirable to minimize the amount of traffic to complete the uplink of all transmissions. Thus, there is a need for an improved protocol for uplink transmissions from multiple terminals.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the present disclosure provides a method for wireless communication. The method includes receiving, at an access point, ranging information from a plurality of wireless devices. The method further includes determining a timing adjustment, for each of the plurality of wireless devices, based on the ranging information. The method further includes transmitting a timing adjustment message to each wireless device, the timing adjustment message indicating the timing adjustment. The method further includes transmitting a scheduling message instructing the plurality of wireless devices to transmit uplink data at a first reference time corrected by the timing adjustment.

In various embodiments, the timing adjustment message and the scheduling message include the same message. In various embodiments, receiving the ranging information can include transmitting a ranging request message requesting a response from one or more of the plurality of wireless devices at a second reference time, receiving at least one response at an offset time, and measuring a time difference between the second reference time and the offset time. In various embodiments, the second reference time can include a time based on the transmission of the ranging request message.

In various embodiments, the reference time can include a time occurring at a time interval after an end of transmission of the ranging request message. In various embodiments, the time interval can include a short interframe space (SIFS) or a point coordination function (PCF) interframe space (PIFS). In various embodiments, the time interval can be agreed between at least one wireless device and the access point.

In various embodiments, measuring the time can include storing a measured time for each of one or more of the plurality of wireless devices. In various embodiments, the one or more wireless devices include a single wireless device. In various embodiments, the one or more wireless devices include more than one wireless device and the plurality of wireless devices each send the response at the reference time by using uplink multiple-user multiple-in-multiple-out (UL MU MIMO) or uplink orthogonal frequency division multiple access (UL OFDMA) or code division multiple access (CDMA) multiplexing.

In various embodiments, the ranging request message can include a request-to-send (RTS) message and the response can include a clear-to-send (CTS) message, and the time interval can include a short interframe space (SIFS). In various embodiments, the ranging request message can include a data or management frame and the response can include an acknowledgement (ACK) or block ACK (BA), and the time interval can include a short interframe space (SIFS). In various embodiments, the ranging request message can include a physical layer (PHY) header and no payload, the PHY header including one or more of an indication of the source address and the purpose or type of the message.

In various embodiments, the response message can include a physical layer (PHY) header and no payload, the PHY header including one or more of an indication of the source address and the purpose or type of the message. In various embodiments, the ranging request message can include the scheduling message and the response can include a clear-to-send (CTS) message, and the time interval can include a short interframe space (SIFS). In various embodiments, determining the timing adjustment can include calculating, for each of the plurality of wireless devices, a timing adjustment as a difference between a largest of timing measurements of the plurality of wireless devices and a timing measurement of each of the plurality of wireless devices.

In various embodiments, indicating the timing adjustment can include transmitting a control or management frame identifying one or more of the plurality of wireless devices and including the timing adjustment for each of the one or more of the plurality of wireless devices. In various embodiments, the scheduling message can include an indication that the transmission of each of the plurality of wireless devices can be to be started at a time based on a reference start time and on the timing adjustment for each of the plurality of wireless devices. In various embodiments, the reference start time can include a short interframe space (SIFS) time after reception of the scheduling message.

In various embodiments, the reference start time can include a point coordination function (PCF) interframe space (PIFS) time after reception of the scheduling message. In various embodiments, the reference start time can include a time agreed between at least one wireless device and access point. In various embodiments, the method can further include adding to the reference start time the timing adjustment.

In various embodiments, the method can further include grouping the plurality of wireless devices such that the timing adjustment can be below a threshold value difference among wireless devices in each group. In various embodiments, transmitting the scheduling message can include indicating that the transmission of each of the plurality of wireless devices can be to be started at a time based on a reference start time and no timing adjustment.

Another aspect provides an access point configured to provide wireless communication. The access point includes a receiver configured to receive ranging information from a plurality of wireless devices. The access point further includes a processor configured to determine a timing adjustment, for each of the plurality of wireless devices, based on the ranging information. The access point further includes a transmitter configured to transmit a timing adjustment message to each wireless device, the timing adjustment message indicating the timing adjustment. The transmitter is further configured to transmit a scheduling message instructing the plurality of wireless devices to transmit uplink data at a first reference time corrected by the timing adjustment.

In various embodiments, the timing adjustment message and the scheduling message include the same message. In various embodiments, the transmitter can be further configured to transmit a ranging request message requesting a response from one or more of the plurality of wireless devices at a second reference time, the receiver can be further configured to receive at least one response at an offset time, and the processor can be further configured to measure a time difference between the second reference time and the offset time. In various embodiments, the second reference time can include a time based on the transmission of the ranging request message.

In various embodiments, the reference time can include a time occurring at a time interval after an end of transmission of the ranging request message. In various embodiments, the time interval can include a short interframe space (SIFS) or a point coordination function (PCF) interframe space (PIFS). In various embodiments, the time interval can be agreed between at least one wireless device and the access point.

In various embodiments, the processor can be configured to measure the time by storing a measured time for each of one or more of the plurality of wireless devices. In various embodiments, the one or more wireless devices include a single wireless device. In various embodiments, the one or more wireless devices include more than one wireless device and the plurality of wireless devices each send the response at the reference time by using uplink multiple-user multiple-in-multiple-out (UL MU MIMO) or uplink orthogonal frequency division multiple access (UL OFDMA) or code division multiple access (CDMA) multiplexing.

In various embodiments, the ranging request message can include a request-to-send (RTS) message and the response can include a clear-to-send (CTS) message, and the time interval can include a short interframe space (SIFS). In various embodiments, the ranging request message can include a data or management frame and the response can include an acknowledgement (ACK) or block ACK (BA), and the time interval can include a short interframe space (SIFS). In various embodiments, the ranging request message can include a physical layer (PHY) header and no payload, the PHY header including one or more of an indication of the source address and the purpose or type of the message.

In various embodiments, the response message can include a physical layer (PHY) header and no payload, the PHY header including one or more of an indication of the source address and the purpose or type of the message. In various embodiments, the ranging request message can include the scheduling message and the response can include a clear-to-send (CTS) message, and the time interval can include a short interframe space (SIFS). In various embodiments, the processor can be configured to determine the timing adjustment by calculating, for each of the plurality of wireless devices, a timing adjustment as a difference between a largest of timing measurements of the plurality of wireless devices and a timing measurement of each of the plurality of wireless devices.

In various embodiments, the transmitter can be configured to indicate the timing adjustment by transmitting a control or management frame identifying one or more of the plurality of wireless devices and including the timing adjustment for each of the one or more of the plurality of wireless devices. In various embodiments, the scheduling message can include an indication that the transmission of each of the plurality of wireless devices can be to be started at a time based on a reference start time and on the timing adjustment for each of the plurality of wireless devices. In various embodiments, the reference start time can include a short interframe space (SIFS) time after reception of the scheduling message.

In various embodiments, the reference start time can include a point coordination function (PCF) interframe space (PIFS) time after reception of the scheduling message. In various embodiments, the reference start time can include a time agreed between at least one wireless device and access point. In various embodiments, the access point can further include adding to the reference start time the timing adjustment.

In various embodiments, the processor can be further configured to group the plurality of wireless devices such that the timing adjustment can be below a threshold value difference among wireless devices in each group. In various embodiments, the transmitter can be configured to transmit the scheduling message indicating that the transmission of each of the plurality of wireless devices can be to be started at a time based on a reference start time and no timing adjustment.

Another aspect provides an apparatus for wireless communication. The apparatus includes means for receiving ranging information from a plurality of wireless devices. The apparatus further includes means for determining a timing adjustment, for each of the plurality of wireless devices, based on the ranging information. The apparatus further includes means for transmitting a timing adjustment message to each wireless device, the timing adjustment message indicating the timing adjustment. The apparatus further includes means for transmitting a scheduling message instructing the plurality of wireless devices to transmit uplink data at a first reference time corrected by the timing adjustment.

In various embodiments, the timing adjustment message and the scheduling message include the same message. In various embodiments, receiving the ranging information can include means for transmitting a ranging request message requesting a response from one or more of the plurality of wireless devices at a second reference time, means for receiving at least one response at an offset time, and means for measuring a time difference between the second reference time and the offset time. In various embodiments, the second reference time can include a time based on the transmission of the ranging request message.

In various embodiments, the reference time can include a time occurring at a time interval after an end of transmission of the ranging request message. In various embodiments, the time interval can include a short interframe space (SIFS) or a point coordination function (PCF) interframe space (PIFS). In various embodiments, the time interval can be agreed between at least one wireless device and the apparatus.

In various embodiments, means for measuring the time can include storing the means for measured time for each of one or more of the plurality of wireless devices. In various embodiments, the one or more wireless devices include a single wireless device. In various embodiments, the one or more wireless devices include more than one wireless device and the plurality of wireless devices each send the response at the reference time by using uplink multiple-user multiple-in-multiple-out (UL MU MIMO) or uplink orthogonal frequency division multiple access (UL OFDMA) or code division multiple access (CDMA) multiplexing.

In various embodiments, the ranging request message can include a request-to-send (RTS) message and the response can include a clear-to-send (CTS) message, and the time interval can include a short interframe space (SIFS). In various embodiments, the ranging request message can include a data or management frame and the response can include an acknowledgement (ACK) or block ACK (BA), and the time interval can include a short interframe space (SIFS). In various embodiments, the ranging request message can include a physical layer (PHY) header and no payload, the PHY header including one or more of an indication of the source address and the purpose or type of the message.

In various embodiments, the response message can include a physical layer (PHY) header and no payload, the PHY header including one or more of an indication of the source address and the purpose or type of the message. In various embodiments, the ranging request message can include the scheduling message and the response can include a clear-to-send (CTS) message, and the time interval can include a short interframe space (SIFS). In various embodiments, means for determining the timing adjustment can include means for calculating, for each of the plurality of wireless devices, a timing adjustment as a difference between a largest of timing measurements of the plurality of wireless devices and a timing measurement of each of the plurality of wireless devices.

In various embodiments, indicating the timing adjustment can include transmitting a control or management frame identifying one or more of the plurality of wireless devices and including the timing adjustment for each of the one or more of the plurality of wireless devices. In various embodiments, the scheduling message can include an indication that the transmission of each of the plurality of wireless devices can be to be started at a time based on a reference start time and on the timing adjustment for each of the plurality of wireless devices. In various embodiments, the reference start time can include a short interframe space (SIFS) time after reception of the scheduling message.

In various embodiments, the reference start time can include a point coordination function (PCF) interframe space (PIFS) time after reception of the scheduling message. In various embodiments, the reference start time can include a time agreed between at least one wireless device and apparatus. In various embodiments, the apparatus can further include means for adding to the reference start time the timing adjustment.

In various embodiments, the apparatus can further include means for grouping the plurality of wireless devices such that the timing adjustment can be below a threshold value difference among wireless devices in each group. In various embodiments, means for transmitting the scheduling message can include means for indicating that the transmission of each of the plurality of wireless devices can be to be started at a time based on a reference start time and no timing adjustment.

Another aspect provides a non-transitory computer-readable medium. The medium includes code that, when executed, causes an apparatus to receive ranging information from a plurality of wireless devices. The medium further includes code that, when executed, causes the apparatus to determine a timing adjustment, for each of the plurality of wireless devices, based on the ranging information. The medium further includes code that, when executed, causes the apparatus to transmit a timing adjustment message to each wireless device, the timing adjustment message indicating the timing adjustment. The medium further includes code that, when executed, causes the apparatus to transmit a scheduling message instructing the plurality of wireless devices to transmit uplink data at a first reference time corrected by the timing adjustment.

In various embodiments, the timing adjustment message and the scheduling message include the same message. In various embodiments, receiving the ranging information can include transmitting a ranging request message requesting a response from one or more of the plurality of wireless devices at a second reference time, receiving at least one response at an offset time, and measuring a time difference between the second reference time and the offset time. In various embodiments, the second reference time can include a time based on the transmission of the ranging request message.

In various embodiments, the reference time can include a time occurring at a time interval after an end of transmission of the ranging request message. In various embodiments, the time interval can include a short interframe space (SIFS) or a point coordination function (PCF) interframe space (PIFS). In various embodiments, the time interval can be agreed between at least one wireless device and the apparatus.

In various embodiments, measuring the time can include storing a measured time for each of one or more of the plurality of wireless devices. In various embodiments, the one or more wireless devices include a single wireless device. In various embodiments, the one or more wireless devices include more than one wireless device and the plurality of wireless devices each send the response at the reference time by using uplink multiple-user multiple-in-multiple-out (UL MU MIMO) or uplink orthogonal frequency division multiple access (UL OFDMA) or code division multiple access (CDMA) multiplexing.

In various embodiments, the ranging request message can include a request-to-send (RTS) message and the response can include a clear-to-send (CTS) message, and the time interval can include a short interframe space (SIFS). In various embodiments, the ranging request message can include a data or management frame and the response can include an acknowledgement (ACK) or block ACK (BA), and the time interval can include a short interframe space (SIFS). In various embodiments, the ranging request message can include a physical layer (PHY) header and no payload, the PHY header including one or more of an indication of the source address and the purpose or type of the message.

In various embodiments, the response message can include a physical layer (PHY) header and no payload, the PHY header including one or more of an indication of the source address and the purpose or type of the message. In various embodiments, the ranging request message can include the scheduling message and the response can include a clear-to-send (CTS) message, and the time interval can include a short interframe space (SIFS). In various embodiments, determining the timing adjustment can include calculating, for each of the plurality of wireless devices, a timing adjustment as a difference between a largest of timing measurements of the plurality of wireless devices and a timing measurement of each of the plurality of wireless devices.

In various embodiments, indicating the timing adjustment can include transmitting a control or management frame identifying one or more of the plurality of wireless devices and including the timing adjustment for each of the one or more of the plurality of wireless devices. In various embodiments, the scheduling message can include an indication that the transmission of each of the plurality of wireless devices can be to be started at a time based on a reference start time and on the timing adjustment for each of the plurality of wireless devices. In various embodiments, the reference start time can include a short interframe space (SIFS) time after reception of the scheduling message.

In various embodiments, the reference start time can include a point coordination function (PCF) interframe space (PIFS) time after reception of the scheduling message. In various embodiments, the reference start time can include a time agreed between at least one wireless device and apparatus. In various embodiments, the medium can further include code that, when executed, causes the apparatus to add to the reference start time the timing adjustment.

In various embodiments, the medium can further include code that, when executed, causes the apparatus to group the plurality of wireless devices such that the timing adjustment can be below a threshold value difference among wireless devices in each group. In various embodiments, transmitting the scheduling message can include indicating that the transmission of each of the plurality of wireless devices can be to be started at a time based on a reference start time and no timing adjustment.

Another aspect provides another method for wireless communication. The method includes transmitting, at a wireless device, ranging information for the wireless device. The method further includes receiving, from an access point, a timing adjustment message indicating a timing adjustment. The method further includes receiving a scheduling message instructing transmission of uplink data at a first reference time corrected by the timing adjustment. The method further includes transmitting uplink data at the reference time corrected by the timing adjustment.

In various embodiments, the timing adjustment message and the scheduling message include the same message. In various embodiments, transmitting the ranging information can include receiving a ranging request message requesting a response from the wireless device at a reference time, and transmitting at least one response at an offset time. In various embodiments, the second reference time can include a time based on the transmission of the ranging request message.

In various embodiments, the reference time can include a time occurring at a time interval after an end of transmission of the ranging request message. In various embodiments, the time interval can include a short interframe space (SIFS) or a point coordination function (PCF) interframe space (PIFS). In various embodiments, the time interval can be agreed between the wireless device and the access point.

In various embodiments, the ranging request message can include a request-to-send (RTS) message and the response can include a clear-to-send (CTS) message, and the time interval can include a short interframe space (SIFS). In various embodiments, the ranging request message can include a data or management frame and the response can include an acknowledgement (ACK) or block ACK (BA), and the time interval can include a short interframe space (SIFS). In various embodiments, the ranging request message can include a physical layer (PHY) header and no payload, the PHY header including one or more of an indication of the source address and the purpose or type of the message.

In various embodiments, the response message can include a physical layer (PHY) header and no payload, the PHY header including one or more of an indication of the source address and the purpose or type of the message. In various embodiments, the ranging request message can include the scheduling message and the response can include a clear-to-send (CTS) message, and the time interval can include a short interframe space (SIFS). In various embodiments, indicating the timing adjustment can include receiving a control or management frame identifying one or more wireless devices and including the timing adjustment for each of the one or more wireless devices.

In various embodiments, the scheduling message can include an indication that the transmission of each of the plurality of wireless devices is to be to be started at a time based on a reference start time and on the timing adjustment for each of the plurality of wireless devices. In various embodiments, the reference start time can include a short interframe space (SIFS) time after reception of the scheduling message. In various embodiments, the reference start time can include a point coordination function (PCF) interframe space (PIFS) time after reception of the scheduling message.

In various embodiments, the reference start time can include a time agreed between at least one wireless device and access point. In various embodiments, the method can further include subtracting from the reference start time the timing adjustment. In various embodiments, receiving the scheduling message can include determining that the transmission of the wireless devices is to be to be started at a time based on a reference start time and no timing adjustment.

Another aspect provides a wireless device configured to provide wireless communication. The device includes a transmitter configured to transmit ranging information for the wireless device. The device further includes a receiver configured to receive, from an access point, a timing adjustment message indicating a timing adjustment. The receiver is further configured to receive a scheduling message instructing transmission of uplink data at a first reference time corrected by the timing adjustment. The transmitter is further configured to transmit uplink data at the reference time corrected by the timing adjustment.

In various embodiments, the timing adjustment message and the scheduling message include the same message. In various embodiments, the receiver can be further configured to receive a ranging request message requesting a response from the wireless device at a reference time, and the transmitter can be further configured to transmit at least one response at an offset time. In various embodiments, the second reference time can include a time based on the transmission of the ranging request message.

In various embodiments, the reference time can include a time occurring at a time interval after an end of transmission of the ranging request message. In various embodiments, the time interval can include a short interframe space (SIFS) or a point coordination function (PCF) interframe space (PIFS). In various embodiments, the time interval can be agreed between the wireless device and the access point.

In various embodiments, the ranging request message can include a request-to-send (RTS) message and the response can include a clear-to-send (CTS) message, and the time interval can include a short interframe space (SIFS). In various embodiments, the ranging request message can include a data or management frame and the response can include an acknowledgement (ACK) or block ACK (BA), and the time interval can include a short interframe space (SIFS). In various embodiments, the ranging request message can include a physical layer (PHY) header and no payload, the PHY header including one or more of an indication of the source address and the purpose or type of the message.

In various embodiments, the response message can include a physical layer (PHY) header and no payload, the PHY header including one or more of an indication of the source address and the purpose or type of the message. In various embodiments, the ranging request message can include the scheduling message and the response can include a clear-to-send (CTS) message, and the time interval can include a short interframe space (SIFS). In various embodiments, indicating the timing adjustment can include receiving a control or management frame identifying one or more wireless devices and including the timing adjustment for each of the one or more wireless devices.

In various embodiments, the scheduling message can include an indication that the transmission of each of the plurality of wireless devices is to be to be started at a time based on a reference start time and on the timing adjustment for each of the plurality of wireless devices. In various embodiments, the reference start time can include a short interframe space (SIFS) time after reception of the scheduling message. In various embodiments, the reference start time can include a point coordination function (PCF) interframe space (PIFS) time after reception of the scheduling message.

In various embodiments, the reference start time can include a time agreed between at least one wireless device and access point. In various embodiments, the wireless device can further include a processor configured to subtract from the reference start time the timing adjustment. In various embodiments, the wireless device can further include a processor configured to determine that the transmission of the wireless devices is to be to be started at a time based on a reference start time and no timing adjustment.

Another aspect provides another apparatus for wireless communication. The apparatus includes means for transmitting ranging information for the apparatus. The apparatus further includes means for receiving, from an access point, a timing adjustment message indicating a timing adjustment. The apparatus further includes means for receiving a scheduling message instructing transmission of uplink data at a first reference time corrected by the timing adjustment. The apparatus further includes means for transmitting uplink data at the reference time corrected by the timing adjustment.

In various embodiments, the timing adjustment message and the scheduling message include the same message. In various embodiments, the apparatus can further include means for receiving a ranging request message requesting a response from one or more of the apparatus at a reference time, and means for transmitting at least one response at an offset time. In various embodiments, the second reference time can include a time based on the transmission of the ranging request message.

In various embodiments, the reference time can include a time occurring at a time interval after an end of transmission of the ranging request message. In various embodiments, the time interval can include a short interframe space (SIFS) or a point coordination function (PCF) interframe space (PIFS). In various embodiments, the time interval can be agreed between the apparatus and the access point.

In various embodiments, the ranging request message can include a request-to-send (RTS) message and the response can include a clear-to-send (CTS) message, and the time interval can include a short interframe space (SIFS). In various embodiments, the ranging request message can include a data or management frame and the response can include an acknowledgement (ACK) or block ACK (BA), and the time interval can include a short interframe space (SIFS). In various embodiments, the ranging request message can include a physical layer (PHY) header and no payload, the PHY header including one or more of an indication of the source address and the purpose or type of the message.

In various embodiments, the response message can include a physical layer (PHY) header and no payload, the PHY header including one or more of an indication of the source address and the purpose or type of the message. In various embodiments, the ranging request message can include the scheduling message and the response can include a clear-to-send (CTS) message, and the time interval can include a short interframe space (SIFS). In various embodiments, indicating the timing adjustment can include receiving a control or management frame identifying one or more of the apparatus and including the timing adjustment for each of the one or more of the apparatus.

In various embodiments, the scheduling message can include an indication that the transmission of each of the multiple apparatus can be to be started at a time based on a reference start time and on the timing adjustment for the apparatus. In various embodiments, the reference start time can include a short interframe space (SIFS) time after reception of the scheduling message. In various embodiments, the reference start time can include a point coordination function (PCF) interframe space (PIFS) time after reception of the scheduling message.

In various embodiments, the reference start time can include a time agreed between the one apparatus and access point. In various embodiments, the apparatus can further include means for subtracting from the reference start time the timing adjustment. In various embodiments, means for receiving the scheduling message can include means for determining that the transmission of the apparatus can be to be started at a time based on a reference start time and no timing adjustment.

Another aspect provides another non-transitory computer-readable medium. The medium includes code that, when executed, causes an apparatus to transmit ranging information for the apparatus. The medium further includes code that, when executed, causes the apparatus to receive, from an access point, a timing adjustment message indicating a timing adjustment. The medium further includes code that, when executed, causes the apparatus to receive a scheduling message instructing transmission of uplink data at a first reference time corrected by the timing adjustment. The medium further includes code that, when executed, causes the apparatus to transmit uplink data at the reference time corrected by the timing adjustment.

In various embodiments, the timing adjustment message and the scheduling message include the same message. In various embodiments, transmitting the ranging information can include receiving a ranging request message requesting a response from one or more of the apparatus at a reference time, and transmitting at least one response at an offset time. In various embodiments, the second reference time can include a time based on the transmission of the ranging request message.

In various embodiments, the reference time can include a time occurring at a time interval after an end of transmission of the ranging request message. In various embodiments, the time interval can include a short interframe space (SIFS) or a point coordination function (PCF) interframe space (PIFS). In various embodiments, the time interval can be agreed between the apparatus and the access point.

In various embodiments, the ranging request message can include a request-to-send (RTS) message and the response can include a clear-to-send (CTS) message, and the time interval can include a short interframe space (SIFS). In various embodiments, the ranging request message can include a data or management frame and the response can include an acknowledgement (ACK) or block ACK (BA), and the time interval can include a short interframe space (SIFS). In various embodiments, the ranging request message can include a physical layer (PHY) header and no payload, the PHY header including one or more of an indication of the source address and the purpose or type of the message.

In various embodiments, the response message can include a physical layer (PHY) header and no payload, the PHY header including one or more of an indication of the source address and the purpose or type of the message. In various embodiments, the ranging request message can include the scheduling message and the response can include a clear-to-send (CTS) message, and the time interval can include a short interframe space (SIFS). In various embodiments, indicating the timing adjustment can include receiving a control or management frame identifying one or more of the apparatus and including the timing adjustment for each of the one or more of the apparatus.

In various embodiments, the scheduling message can include an indication that the transmission of each of the multiple apparatus can be to be started at a time based on a reference start time and on the timing adjustment for the apparatus. In various embodiments, the reference start time can include a short interframe space (SIFS) time after reception of the scheduling message. In various embodiments, the reference start time can include a point coordination function (PCF) interframe space (PIFS) time after reception of the scheduling message.

In various embodiments, the reference start time can include a time agreed between the one apparatus and access point. In various embodiments, the medium can further include code that, when executed, causes the apparatus to subtract from the reference start time the timing adjustment. In various embodiments, the medium can further include code that, when executed, causes the apparatus to determine that the transmission of the apparatus can be to be started at a time based on a reference start time and no timing adjustment.

### BRIEF DESCRIPTION OF THE DRAWINGS

FIG. 1 illustrates a multiple-access multiple-input multiple-output (MIMO) system with access points and STA.

FIG. 2 illustrates a block diagram of the AP 110 and two STAs 120m and 120x in a MIMO system.

FIG. 3 illustrates various components that can be utilized in a wireless device that can be employed within a wireless communication system.

FIG. 4 shows a time diagram of an example frame exchange of an uplink (UL) MU-MIMO communication.

FIG. 5 shows a time diagram of another example frame exchange of an UL-MU-MIMO communication.

FIG. 6 shows a time diagram of another example frame exchange of an UL-MU-MIMO communication.

FIG. 7 shows a time diagram of another example frame exchange of an UL-MU-MIMO communication.

FIG. 8 shows a diagram of one embodiment of a request to transmit (RTX) frame.

FIG. 9 shows a diagram of another embodiment of a RTX frame.

FIG. 10 shows a time diagram of an example frame exchange including a station scheduling frame (SSF) and a station information frame (SIF).

FIG. 11 shows a time diagram of another example frame exchange including a station scheduling frame (SSF) and a station information frame (SIF).

FIG. 12 shows a diagram of one embodiment of a clear to transmit (CTX) frame.

FIG. 13 shows a diagram of another embodiment of a CTX frame.

FIG. 14 shows a diagram of another embodiment of a CTX frame.

FIG. 15 shows a diagram of another embodiment of a CTX frame.

FIG. 16 shows a time diagram of another example frame exchange of an UL-MU-MIMO communication.

FIG. 17 shows another example frame exchange of an UL-MU-MIMO communication.

FIG. 18 shows an example frame exchange including a trigger message.

FIG. 19 shows another example frame exchange including a trigger message.

FIG. 20 shows another example frame exchange including a trigger message.

FIGS. 21A-21C show time sequence diagrams that illustrate various embodiments of timing offset exchanges.

FIG. 22 shows a flowchart for an exemplary method of wireless communication that can be employed within the wireless communication system of FIG. 1.

FIG. 23 shows a flowchart for another exemplary method of wireless communication that can be employed within the wireless communication system of FIG. 1.

FIG. 24 is a functional block diagram of an apparatus for wireless communication.

FIG. 25 is a functional block diagram of another apparatus for wireless communication.

### DETAILED DESCRIPTION

Various aspects of the novel systems, apparatuses, and methods are described more fully hereinafter with reference to the accompanying drawings. The teachings disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus can be implemented or a method can be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein can be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Wireless network technologies can include various types of wireless local area networks (WLANs). A WLAN can be used to interconnect nearby devices together, employing widely used networking protocols. The various aspects described herein can apply to any communication standard, such as Wi-Fi or, more generally, any member of the IEEE 802.11 family of wireless protocols.

In some aspects, wireless signals can be transmitted according to a high-efficiency 802.11 protocol using orthogonal frequency-division multiplexing (OFDM), direct-sequence spread spectrum (DSSS) communications, a combination of OFDM and DSSS communications, or other schemes. Implementations of the high-efficiency 802.11 protocol can be used for Internet access, sensors, metering, smart grid networks, or other wireless applications. Advantageously, aspects of certain devices implementing this particular wireless protocol can consume less power than devices implementing other wireless protocols, can be used to transmit wireless signals across short distances, and/or can be able to transmit signals less likely to be blocked by objects, such as humans.

In some implementations, a WLAN includes various devices which are the components that access the wireless network. For example, there can be two types of devices: access points (“APs”) and clients (also referred to as stations, or “STAs”). In general, an AP serves as a hub or base station for the WLAN and an STA serves as a user of the WLAN. For example, a STA can be a laptop computer, a personal digital assistant (PDA), a mobile phone, etc. In an example, an STA connects to an AP via a Wi-Fi (e.g., IEEE 802.11 protocol such as 802.11ah) compliant wireless link to obtain general connectivity to the Internet or to other wide area networks. In some implementations an STA can also be used as an AP.

The techniques described herein can be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system can utilize sufficiently different directions to simultaneously transmit data belonging to multiple STA. A TDMA system can allow multiple STA to share the same frequency channel by dividing the transmission signal into different time slots, each time slot being assigned to different STA. A TDMA system can implement GSM or some other standards known in the art. An OFDMA system utilizes orthogonal frequency division multiplexing (OFDM), which is a modulation technique that partitions the overall system bandwidth into multiple orthogonal sub-carriers. These sub-carriers can also be called tones, bins, etc. With OFDM, each subcarrier can be independently modulated with data. An OFDM system can implement IEEE 802.11 or some other standards known in the art. An SC-FDMA system can utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA. A SC-FDMA system can implement 3GPP-LTE (3rd Generation Partnership Project Long Term Evolution) or other standards.

The teachings herein can be incorporated into (e.g., implemented within or performed by) a variety of wired or wireless apparatuses (e.g., nodes). In some aspects, a wireless node implemented in accordance with the teachings herein can comprise an access point or an access terminal.

An access point (“AP”) can comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ES S”), Radio Base Station (“RBS”), or some other terminology.

A station “STA” can also comprise, be implemented as, or known as a user terminal, an access terminal (“AT”), a subscriber station, a subscriber unit, a mobile station, a remote station, a remote terminal, a user agent, a user device, user equipment, or some other terminology. In some implementations an access terminal can comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein can be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

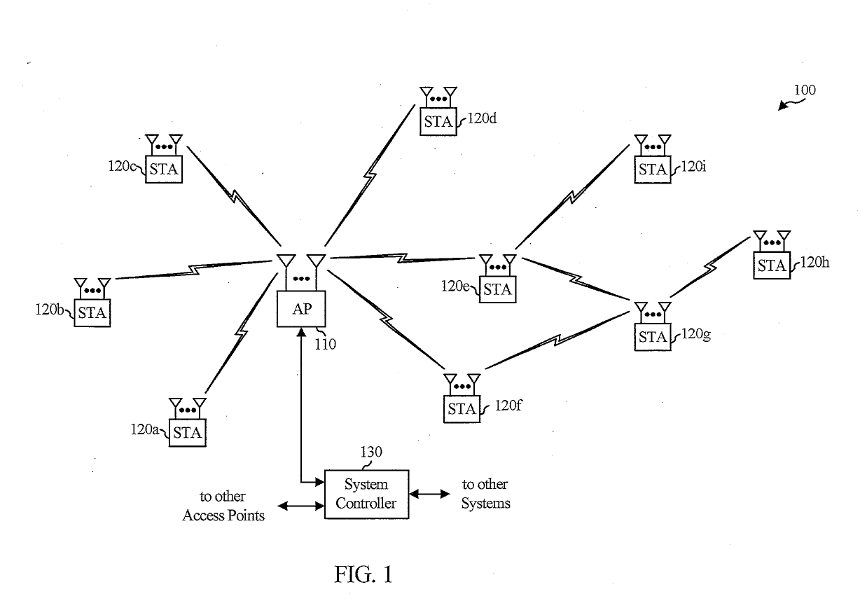

FIG. 1 is a diagram that illustrates a multiple-access multiple-input multiple-output (MIMO) system 100 with access points and STA. For simplicity, only one AP 110 is shown in FIG. 1. An access point is generally a fixed station that communicates with the STA and can also be referred to as a base station or using some other terminology. A user terminal or STA can be fixed or mobile and can also be referred to as a mobile station or a wireless device, or using some other terminology. The AP 110 can communicate with one or more STAs 120 at any given moment on the downlink and uplink. The downlink (i.e., forward link) is the communication link from the access point to the STA, and the uplink (i.e., reverse link) is the communication link from the STA to the access point. A STA can also communicate peer-to-peer with another STA. A system controller 130 couples to and provides coordination and control for the access points.

While portions of the following disclosure will describe STAs 120 capable of communicating via Spatial Division Multiple Access (SDMA), for certain aspects, the STAs 120 can also include some STA that do not support SDMA. Thus, for such aspects, the AP 110 can be configured to communicate with both SDMA and non-SDMA STA. This approach can conveniently allow older versions of STA (“legacy” stations) that do not support SDMA to remain deployed in an enterprise, extending their useful lifetime, while allowing newer SDMA STA to be introduced as deemed appropriate.

The wireless communication system 100 employs multiple transmit and multiple receive antennas for data transmission on the downlink and uplink. The AP 110 is equipped with Nₐₚ antennas and represents the multiple-input (MI) for downlink transmissions and the multiple-output (MO) for uplink transmissions. A set of K selected STAs 120 collectively represents the multiple-output for downlink transmissions and the multiple-input for uplink transmissions. For pure SDMA, it is desired to have Nₐₚ≦K≦1 if the data symbol streams for the K STA are not multiplexed in code, frequency or time by some means K can be greater than Nₐₚ if the data symbol streams can be multiplexed using TDMA technique, different code channels with CDMA, disjoint sets of sub-bands with OFDM, and so on. Each selected STA can transmit user-specific data to and/or receive user-specific data from the access point. In general, each selected STA can be equipped with one or multiple antennas (i.e., Nᵤₜ≧1). The K selected STA can have the same number of antennas, or one or more STA can have a different number of antennas.

The wireless communication system 100, when configured as an SDMA system, can be a time division duplex (TDD) system or a frequency division duplex (FDD) system. For a TDD system, the downlink and uplink share the same frequency band. For an FDD system, the downlink and uplink use different frequency bands. The wireless communication system 100, when configured as a MIMO system, can also utilize a single carrier or multiple carriers for transmission. Each STA can be equipped with a single antenna (e.g., in order to keep costs down) or multiple antennas (e.g., where the additional cost can be supported). The wireless communication system 100 can also be a TDMA system if the STAs 120 share the same frequency channel by dividing transmission/reception into different time slots, where each time slot can be assigned to a different STA 120.

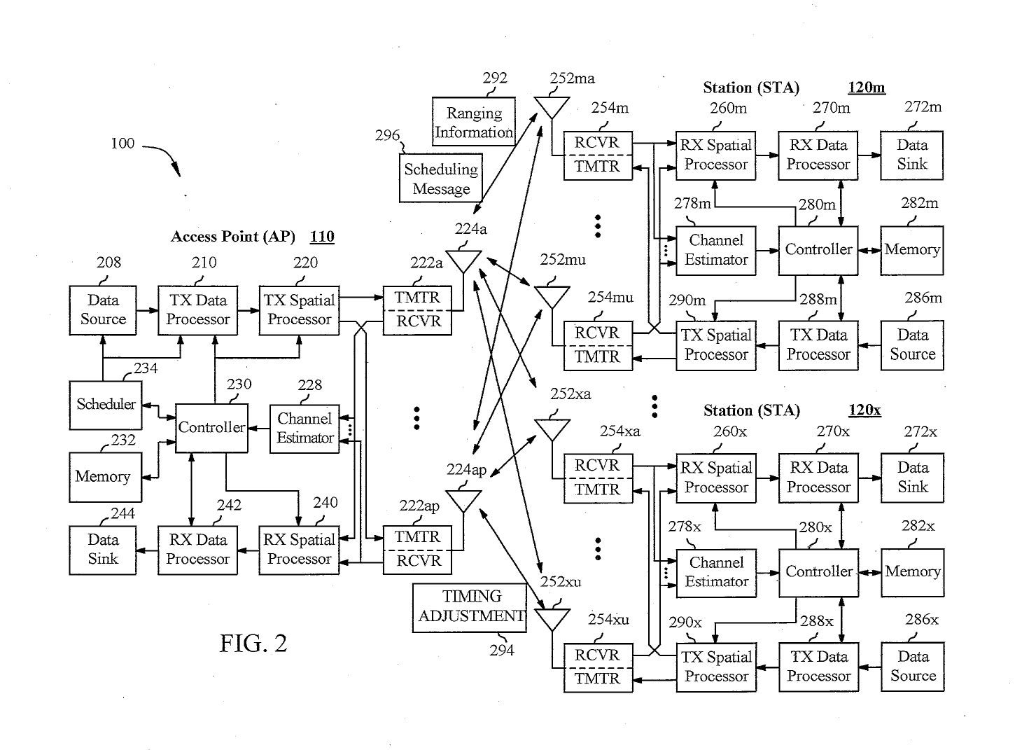

FIG. 2 illustrates a block diagram of the AP 110 and two STAs 120m and 120x in the wireless communications system 100 of FIG. 1 configured as a MIMO system. The AP 110 is equipped with Nₜ antennas 224a through 224ap. The STA 120m is equipped with N_{ut,m} antennas 252ₘₐ through 252ₘᵤ, and the STA 120x is equipped with N_{ut,x} antennas 252ₓₐ through 252ₓᵤ. The AP 110 is a transmitting entity for the downlink and a receiving entity for the uplink. The STA 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nᵤₚ STA are selected for simultaneous transmission on the uplink, and N_{dn} STA are selected for simultaneous transmission on the downlink. Nᵤₚ may or may not be equal to N_{dn}, and Nᵤₚ and N_{dn} can be static values or can change for each scheduling interval. Beam-steering or some other spatial processing technique can be used at the AP 110 and/or the STA 120.

On the uplink, at each STA 120 selected for uplink transmission, a TX data processor 288 receives traffic data from a data source 286 and control data from a controller 280. The TX data processor 288 processes (e.g., encodes, interleaves, and modulates) the traffic data for the STA based on the coding and modulation schemes associated with the rate selected for the STA and provides a data symbol stream. A TX spatial processor 290 performs spatial processing on the data symbol stream and provides N_{ut,m} transmit symbol streams for the N_{ut,m} antennas. Each transmitter unit (TMTR) of a transceiver 254 receives and processes (e.g., converts to analog, amplifies, filters, and frequency upconverts) a respective transmit symbol stream to generate an uplink signal. N_{ut,m} transmitter units of the transceivers 254 provide N_{ut,m} uplink signals for transmission from N_{ut,m} antennas 252, for example to transmit to the AP 110.

Nᵤₚ STA can be scheduled for simultaneous transmission on the uplink. Each of these STA can perform spatial processing on its respective data symbol stream and transmit its respective set of transmit symbol streams on the uplink to the AP 110.

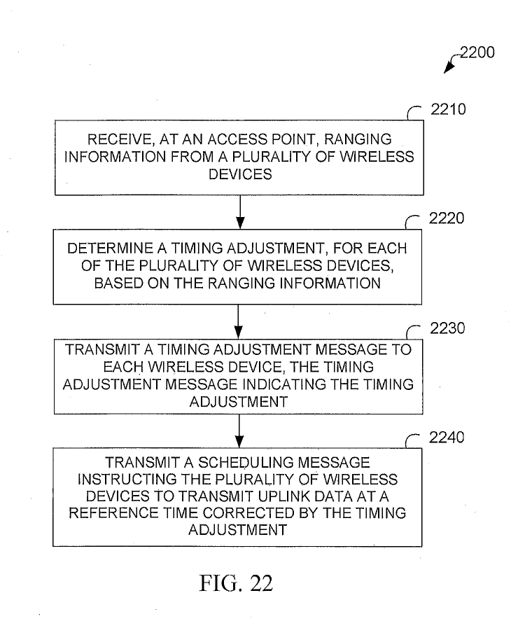

At the AP 110, Nᵤₚ antennas 224a through 224ₐₚ receive the uplink signals from all Nᵤₚ STA transmitting on the uplink. Each antenna 224 provides a received signal to a respective receiver unit (RCVR) of a transceiver 222. Each receiver unit of the transceiver 222 performs processing complementary to that performed by transmitter unit of the transceiver 254 and provides a received symbol stream. An RX spatial processor 240 performs receiver spatial processing on the Nᵤₚ received symbol streams from Nᵤₚ receiver units of the transceivers 222 and provides Nᵤₚ recovered uplink data symbol streams. The receiver spatial processing can be performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective STA. An RX data processor 242 processes (e.g., demodulates, deinterleaves, and decodes) each recovered uplink data symbol stream in accordance with the rate used for that stream to obtain decoded data. The decoded data for each STA can be provided to a data sink 244 for storage and/or a controller 230 for further processing. In various embodiments discussed herein with respect to FIG. 22, the AP 110 can be configured to receive ranging information 292 from the STA 120m, for example via the RCVR of the transceiver 222a.

On the downlink, at the AP 110, a TX data processor 210 receives traffic data from a data source 208 for N_{dn} STA scheduled for downlink transmission, control data from a controller 230, and possibly other data from a scheduler 234. The various types of data can be sent on different transport channels. TX data processor 210 processes (e.g., encodes, interleaves, and modulates) the traffic data for each STA based on the rate selected for that STA. The TX data processor 210 provides N_{dn} downlink data symbol streams for the N_{dn} STA. A TX spatial processor 220 performs spatial processing (such as a precoding or beamforming) on the N_{dn} downlink data symbol streams, and provides Nᵤₚ transmit symbol streams for the Nᵤₚ antennas. Each transmitter unit of the transceiver 222 receives and processes a respective transmit symbol stream to generate a downlink signal. Nᵤₚ transmitter units of the transceivers 222 can provide Nᵤₚ downlink signals for transmission from Nᵤₚ antennas 224, for example to transmit to the STAs 120. In various embodiments discussed herein with respect to FIG. 22, the AP 110 can be configured to transmit a timing adjustment 294 to the STA 120x, for example via the TMTR of the transceiver 222ap. In various embodiments discussed herein with respect to FIG. 22, the AP 110 can be configured to transmit a scheduling message 296 to the STA 120x, for example via the TMTR of the transceiver 222ap.

At each STA 120, N_{ut,m} antennas 252 receive the Nᵤₚ downlink signals from the AP 110. Each receiver unit (RCVR) of the transceiver 254 processes a received signal from an associated antenna 252 and provides a received symbol stream. An RX spatial processor 260 performs receiver spatial processing on N_{ut,m} received symbol streams from N_{ut,m} receiver units of the transceivers 254 and provides a recovered downlink data symbol stream for the STA 120. The receiver spatial processing can be performed in accordance with the CCMI, MMSE, or some other technique. An RX data processor 270 processes (e.g., demodulates, deinterleaves and decodes) the recovered downlink data symbol stream to obtain decoded data for the STA.

At each STA 120, a channel estimator 278 estimates the downlink channel response and provides downlink channel estimates, which can include channel gain estimates, SNR estimates, noise variance and so on. Similarly, a channel estimator 228 estimates the uplink channel response and provides uplink channel estimates. Controller 280 for each STA typically derives the spatial filter matrix for the STA based on the downlink channel response matrix H_{dn,m} for that STA. Controller 230 derives the spatial filter matrix for the access point based on the effective uplink channel response matrix H_{up,eff}. The controller 280 for each STA can send feedback information (e.g., the downlink and/or uplink eigenvectors, eigenvalues, SNR estimates, and so on) to the AP 110. The controllers 230 and 280 can also control the operation of various processing units at the AP 110 and STA 120, respectively.

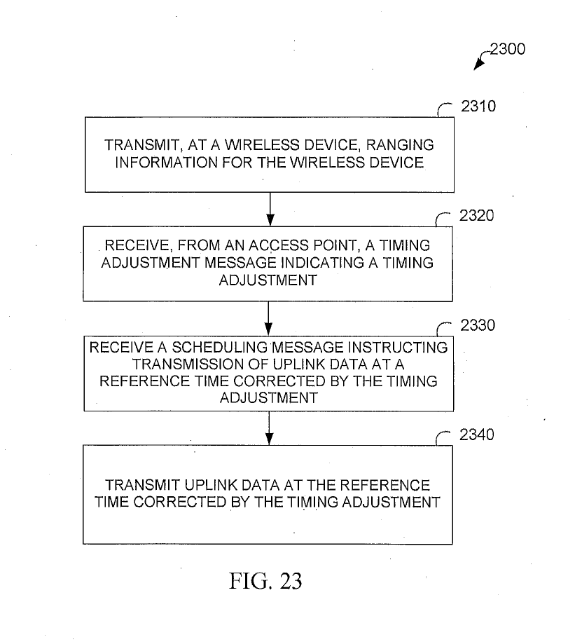

In various embodiments discussed herein with respect to FIG. 23, the STA 120m can be configured to transmit ranging information 292 to the AP 110, for example via the TMTR of the transceiver 254ma. In various embodiments discussed herein with respect to FIG. 23, the STA 120x can be configured to receive a timing adjustment 294 from the AP 110, for example via the RCVR of the transceiver 254xu. In various embodiments discussed herein with respect to FIG. 23, the STA 120m can be configured to receive a scheduling message 296 from the AP 110, for example via the RCVR of the transceiver 254m. In various embodiments discussed herein with respect to FIG. 23, the STA 120m can be configured to transmit uplink data to the AP 110, for example via the TMTR of the transceiver 254ma.

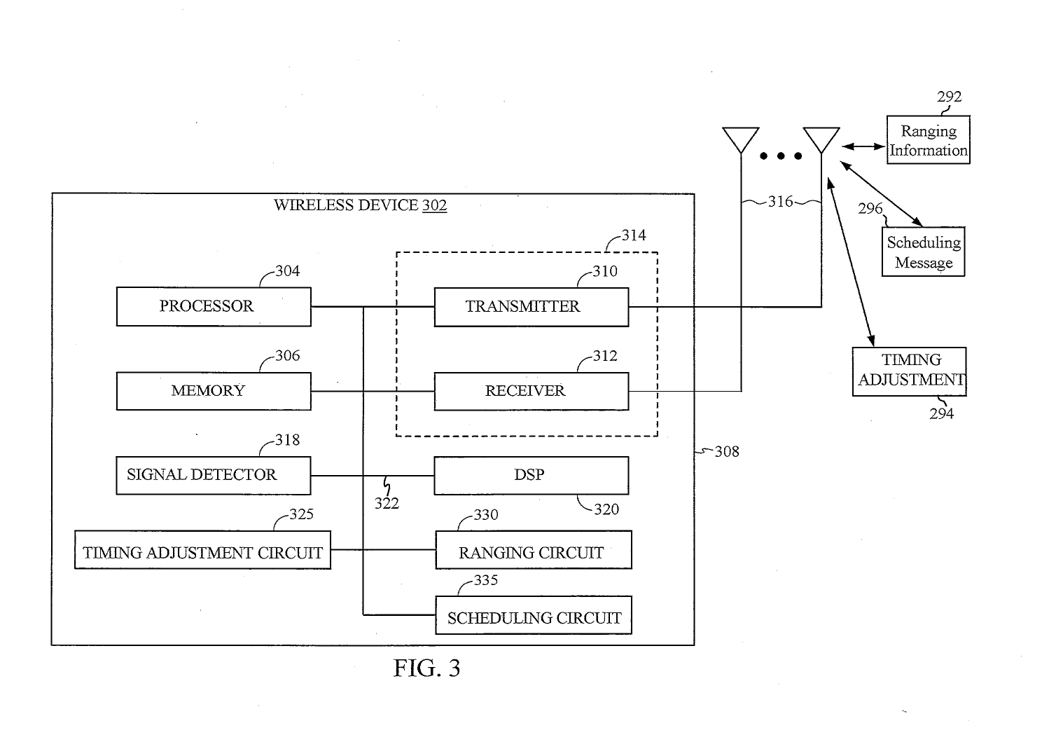

FIG. 3 illustrates various components that can be utilized in a wireless device 302 that can be employed within the wireless communication system 100. The wireless device 302 is an example of a device that can be configured to implement the various methods described herein. The wireless device 302 can implement an AP 110 or a STA 120.

The wireless device 302 can include a processor 304 which controls operation of the wireless device 302. The processor 304 can also be referred to as a central processing unit (CPU). Memory 306, which can include both read-only memory (ROM) and random access memory (RAM), provides instructions and data to the processor 304. A portion of the memory 306 can also include non-volatile random access memory (NVRAM). The processor 304 can perform logical and arithmetic operations based on program instructions stored within the memory 306. The instructions in the memory 306 can be executable to implement the methods described herein.

The processor 304 can comprise or be a component of a processing system implemented with one or more processors. The one or more processors can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system can also include machine-readable media for storing software. Software shall be construed broadly to mean any type of instructions, whether referred to as software, firmware, middleware, microcode, hardware description language, or otherwise. Instructions can include code (e.g., in source code format, binary code format, executable code format, or any other suitable format of code). The instructions, when executed by the one or more processors, cause the processing system to perform the various functions described herein.

The wireless device 302 can also include a housing 308 that can include a transmitter 310 and a receiver 312 to allow transmission and reception of data between the wireless device 302 and a remote location. The transmitter 310 and receiver 312 can be combined into a transceiver 314. A single or a plurality of transceiver antennas 316 can be attached to the housing 308 and electrically coupled to the transceiver 314. The wireless device 302 can also include (not shown) multiple transmitters, multiple receivers, and multiple transceivers.

The wireless device 302 can also include a signal detector 318 that can be used in an effort to detect and quantify the level of signals received by the transceiver 314. The signal detector 318 can detect such signals as total energy, energy per subcarrier per symbol, power spectral density and other signals. The wireless device 302 can also include a digital signal processor (DSP) 320 for use in processing signals.

The various components of the wireless device 302 can be coupled together by a bus system 322, which can include a power bus, a control signal bus, and a status signal bus in addition to a data bus.

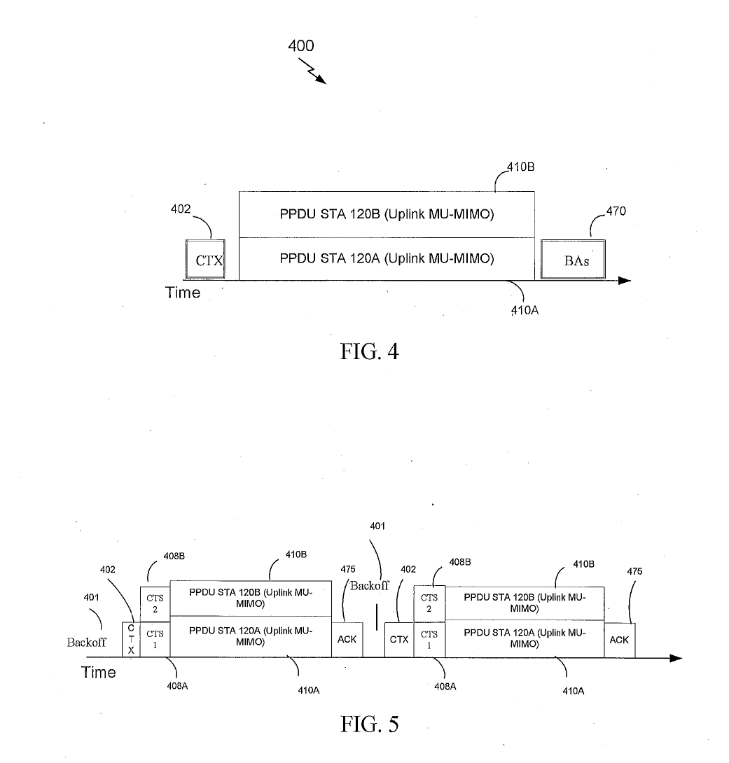

Certain aspects of the present disclosure support transmitting an uplink (UL) signal from multiple STAs to an AP. In some embodiments, the UL signal can be transmitted in a multi-user MIMO (MU-MIMO) system. Alternatively, the UL signal can be transmitted in a multi-user FDMA (MU-FDMA) or similar FDMA system. Specifically, FIGS. 4-7, 10-11, and 16-20 illustrate UL-MU-MIMO transmissions 410A, 410B, 1050A, and 1050B that would apply equally to UL-FDMA transmissions. In these embodiments, UL-MU-MIMO or UL-FDMA transmissions can be sent simultaneously from multiple STAs to an AP and can create efficiencies in wireless communication.

In various embodiments discussed herein with respect to FIG. 22, the wireless device 302 can be configured as an access point (for example, AP 110 of FIG. 2), and can be configured to receive ranging information 292 from a STA, for example via the receiver 312, in conjunction with a ranging circuit 3320. In various embodiments, wireless device 302 can be configured to transmit a timing adjustment 294 to a STA, for example via the transmitter 310, in conjunction with a timing adjustment circuit configured to determine the timing adjustment 294. In various embodiments, the wireless device 302 can be configured to transmit a scheduling message 296 to a STA, for example via the transmitter 310, in conjunction with a scheduling circuit.

In various embodiments discussed herein with respect to FIG. 23, the wireless device 302 can be configured as a STA (for example, STA 120m of FIG. 2), and can be configured to transmit ranging information 292 to an AP, for example via the transmitter 310, in conjunction with the ranging circuit 330 configured to determine the ranging information. In various embodiments, the wireless device 302 can be configured to receive a timing adjustment 294 from an AP, for example via the receiver 312, in conjunction with the timing adjustment circuit configured to adjust transmission timing in accordance with the timing adjustment 294. In various embodiments, the wireless device 302 can be configured to receive a scheduling message 296 from an AP, for example via the receiver 312, in conjunction with the scheduling circuit 335 configured to schedule transmissions in accordance with the scheduling message 296. In various embodiments, the wireless device 302 can be configured to transmit uplink data to an AP, for example via the transmitter 310.

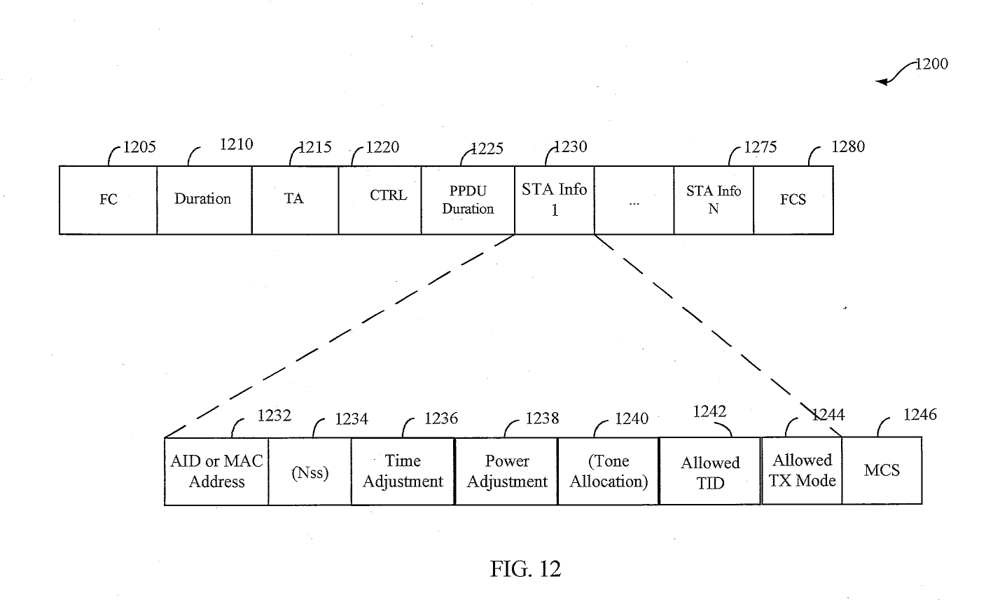

FIG. 4 is a time sequence diagram illustrating an example of an UL-MU-MIMO protocol 400 that can be used for UL communications. As shown in FIG. 4 and in conjunction with FIG. 1, an AP 110 can transmit a clear to transmit (CTX) message 402 to the STAs 120 indicating which STAs can participate in the UL-MU-MIMO scheme, such that a particular STA knows to start an UL-MU-MIMO. An example of a CTX frame structure is described more fully below with reference to FIGS. 12-15.

Once a STA 120 receives a CTX message 402 from the AP 110 where the STA is listed, the STA can transmit the UL-MU-MIMO transmission 410. In FIG. 4, STA 120A and STA 120B transmit UL-MU-MIMO transmission 410A and 410B containing physical layer convergence protocol (PLCP) protocol data units (PPDUs). Upon receiving the UL-MU-MIMO transmission 410, the AP 110 can transmit block acknowledgments (BAs) 470 to the STAs 120.

Not all APs or STAs 120 can support UL-MU-MIMO or UL-FDMA operation. A capability indication from a STA 120 can be indicated in a high efficiency wireless (HEW) capability element that is included in an association request or probe request and can include a bit indicating capability, the maximum number of spatial streams a STA 120 can use in a UL-MU-MIMO transmission, the frequencies a STA 120 can use in a UL-FDMA transmission, the minimum and maximum power and granularity in the power backoff, and the minimum and maximum time adjustment a STA 120 can perform.

A capability indication from an AP can be indicated in a HEW capability element that is included in an association response, beacon or probe response and can include a bit indicating capability, the maximum number of spatial streams a single STA 120 can use in a UL-MU-MIMO transmission, the frequencies a single STA 120 can use in a UL-FDMA transmission, the required power control granularity, and the required minimum and maximum time adjustment a STA 120 should be able to perform.

In one embodiment, capable STAs 120 can request to a capable AP to be part of the UL-MU-MIMO (or UL-FDMA) protocol by sending a management frame to AP indicating request for enablement of the use of UL-MU-MIMO feature. In one aspect, an AP 110 can respond by granting the use of the UL-MU-MIMO feature or denying it. Once the use of the UL-MU-MIMO is granted, the STA 120 can expect a CTX message 402 at a variety of times. Additionally, once a STA 120 is enabled to operate the UL-MU-MIMO feature, the STA 120 can be subject to follow a certain operation mode. If multiple operation modes are possible, an AP can indicate to the STA 120 which mode to use in a HEW capability element or in an operation element. In one aspect the STAs 120 can change the operation modes and parameters dynamically during operation by sending a different operating element to the AP 110. In another aspect the AP 110 can switch operation modes dynamically during operation by sending an updated operating element to a STA 120 or in a beacon. In another aspect, the operation modes can be indicated in the setup phase and can be setup per STA 120 or for a group of STAs 120. In another aspect the operation mode can be specified per traffic identifier (TID).

FIG. 5 is a time sequence diagram that, in conjunction with FIG. 1, illustrates an example of an operation mode of a UL-MU-MIMO transmission. In this embodiment, a STA 120 receives a CTX message 402 from an AP 110 and sends an immediate response to the AP 110. The response can be in the form of a clear to send (CTS) 408 or another similar signal. In one aspect, requirement to send a CTS can be indicated in the CTX message 402 or can be indicated in the setup phase of the communication. As shown in FIG. 5, STA 120 A and STA 120B can transmit a FIRST CTS 408A and SECOND CTS 408B message in response to receiving the CTX message 402. The modulation and coding scheme (MCS) of the FIRST CTS 408A and SECOND CTS 408B can be based on the MCS of the CTX message 402. In this embodiment, FIRST CTS 408A and SECOND CTS 408B contain the same bits and the same scrambling sequence so that they can be transmitted to the AP 110 at the same time. The duration field of the CTS 408 signals can be based on the duration field in the CTX by removing the time for the CTX PPDU. The UL-MU-MIMO transmission 410A and 410B are then sent by the STAs 120A and 120B as listed in the CTX message 402 signals. The AP 110 can then send acknowledgment (ACK) signals the STAs 120A and 120B. In some aspects, the ACK signals can be serial ACK signals to each station or BAs. In some aspects the ACKs can be polled. This embodiment creates efficiencies by simultaneously transmitting CTS 408 signals from multiple STAs to an AP 110 instead of sequentially, which saves time and reduces the possibility of interference.

FIG. 6 is a time sequence diagram that, in conjunction with FIG. 1, illustrates another example of an operation mode of a UL-MU-MIMO transmission. In this embodiment, STAs 120A and 120B receive a CTX message 402 from an AP 110 and are allowed to start and UL-MU-MIMO transmission a time (T) 406 after the end of the PPDU carrying the CTX message 402. The T 406 can be a short interframe space (SIFS), point interframe space (PIFS), or another time potentially adjusted with additional offsets as indicated by an AP 110 in the CTX message 402 or via a management frame. The SIFS and PIFS time can be fixed in a standard or indicated by an AP 110 in the CTX message 402 or in a management frame. The benefit of T 406 can be to improve synchronization or to allow a STAs 120A and 120B time to process the CTX message 402 or other messages before transmission.

Referring to FIGS. 4-6, in conjunction with FIG. 1, the UL-MU-MIMO transmission 410 can have the same duration. The duration of the UL-MU-MIMO transmission 410 for STA utilizing the UL-MU-MIMO feature can be indicated in the CTX message 402 or during the setup phase. To generate a PPDU of the required duration, a STA 120 can build a PLCP service data unit (PSDU) so that the length of the PPDU matches the length indicated in the CTX message 402. In another aspect, a STA 120 can adjust the level of data aggregation in a media access control (MAC) protocol data unit (A-MPDU) or the level of data aggregation in a MAC service data units (A-MSDU) to approach the target length. In another aspect, a STA 120 can add end of file (EOF) padding delimiters to reach the target length. In another approach the padding or the EOF pad fields are added at the beginning of the A-MPDU. One of the benefits of having all the UL-MU-MIMO transmissions the same length is that the power level of the transmission will remain constant.

In some embodiments, a STA 120 can have data to upload to the AP but the STA 120 has not received a CTX message 402 or other signal indicating that the STA 120 can start a UL-MU-MIMO transmission.

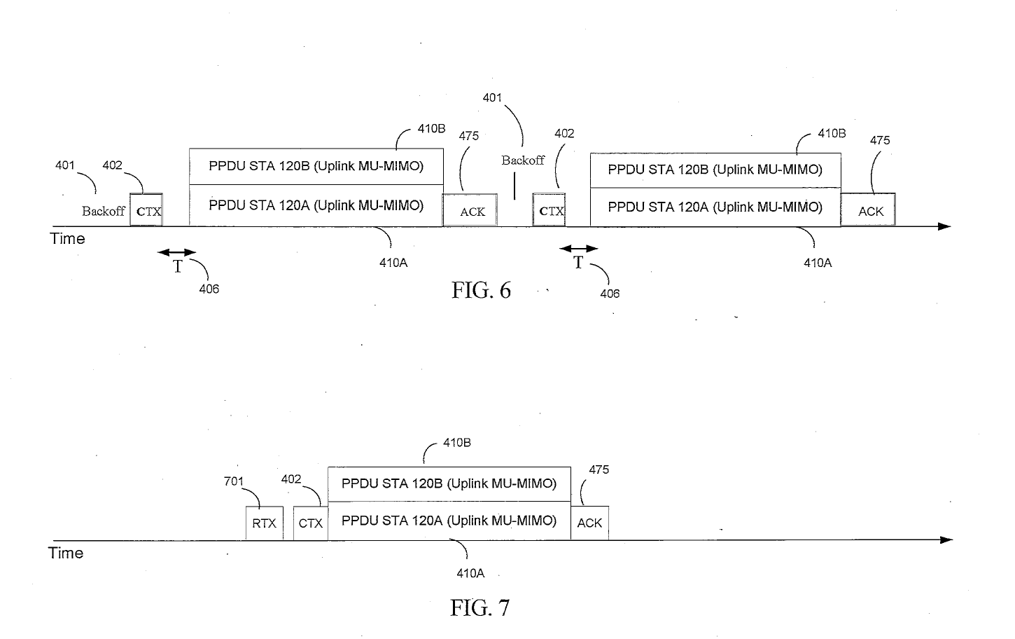

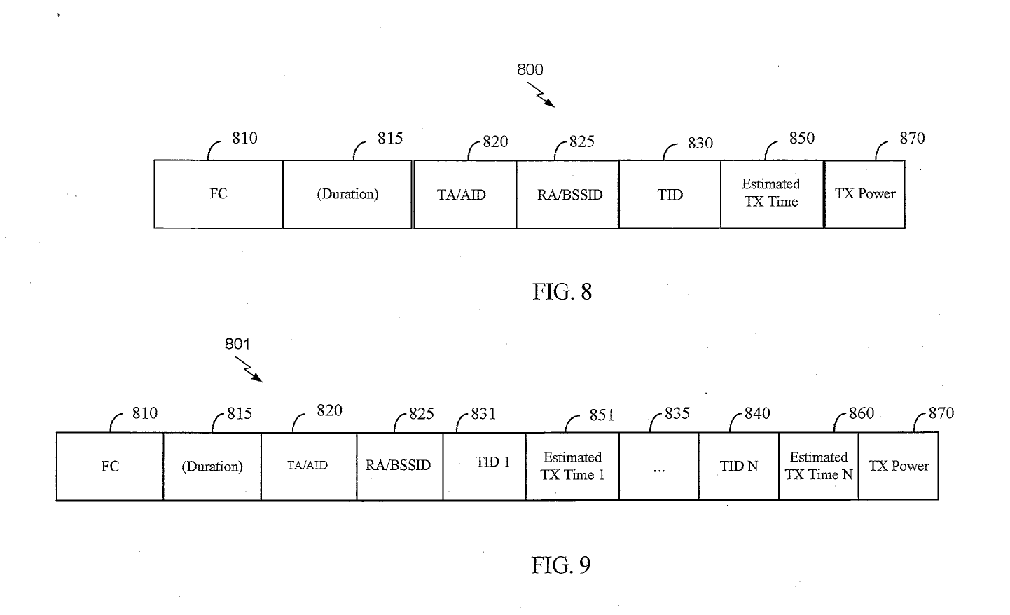

In one operation mode, the STAs 120 may not transmit outside an UL-MU-MIMO transmission opportunity (TXOP) (e.g., after CTX message 402). In another operation mode STAs 120 can transmit frames to initialize a UL-MU-MIMO transmission, and then can transmit during the UL-MU-MIMO TXOP, if for example, they are instructed to do so in a CTX message 402. In one embodiment, the frame to initialize a UL-MU-MIMO transmission can be a request to transmit (RTX), a frame specifically designed for this purpose (an example of a RTX frame structure is described more fully below with reference to FIGS. 8 and 9). The RTX frames can be the only frames a STA 120 is allowed to use to initiate a UL MU MIMO TXOP. In one embodiment, the STA may not transmit outside an UL-MU-MIMO TXOP other than by sending an RTX. In another embodiment, a frame to initialize an UL MU MIMO transmission can be any frame which indicates to an AP 110 that a STA 120 has data to send. It can be pre-negotiated that these frames indicate a UL MU MIMO TXOP request. For example, the following can be used to indicate that a STA 120 has data to send and is requesting an UL MU MIMO TXOP: an RTS, a data frame or QoS Null frame with bits 8-15 of the QoS control frame set to indicate more data, or a PS poll. In one embodiment, the STA may not transmit outside an UL MU MIMO TXOP other than by sending frames to trigger this TXOP, where this frame can be an RTS, PS poll, or QOS null. In another embodiment, the STA can send single user uplink data as usual, and can indicate a request for a UL MU MIMO TXOP by setting bits in the QoS control frame of its data packet. FIG. 7 is a time sequence diagram illustrating, in conjunction with FIG. 1, an example where the frame to initialize a UL-MU-MIMO is a RTX 701. In this embodiment the STA 120 sends to the AP 110 a RTX 701 that includes information regarding the UL-MU-MIMO transmission. As shown in FIG. 7, the AP 110 can respond to the RTX 701 with a CTX message 402 granting an UL-MU-MIMO TXOP to send the UL-MU-MIMO transmission 410 immediately following the CTX message 402. In another aspect, the AP 110 can respond with a CTS that grants a single-user (SU) UL TXOP. In another aspect, the AP 110 can respond with a frame (e.g., ACK or CTX with a special indication) that acknowledges reception of the RTX 701 but does not grant an immediate UL-MU-MIMO TXOP. In another aspect, the AP 110 can respond with a frame that acknowledges reception of the RTX 701, does not grant an immediate UL-MU-MIMO TXOP, but grants a delayed UL-MU-MIMO TXOP and can identify the time of the TXOP is granted. In this embodiment, the AP 110 can send a CTX message 402 to start the UL-MU-MIMO at the granted time.

In another aspect, the AP 110 can respond to the RTX 701 with an ACK or other response signal which does not grant the STA 120 an UL-MU-MIMO transmission but indicates that the STA 120 shall wait for a time (T) before attempting another transmission (e.g., sending another RTX). In this aspect the time (T) can be indicated by the AP 110 in the setup phase or in the response signal. In another aspect an AP 110 and a STA 120 can agree on a time which the STA 120 can transmit a RTX 701, RTS, PS-poll, or any other request for a UL-MU-MIMO TXOP.

In another operation mode, STAs 120 can transmit requests for UL-MU-MIMO transmissions 410 in accordance with regular contention protocol. In another aspect, the contention parameters for STAs 120 using UL-MU-MIMO are set to a different value than for other STA that are not using the UL-MU-MIMO feature. In this embodiment, the AP 110 can indicate the value of the contention parameters in a beacon, association response or through a management frame. In another aspect, the AP 110 can provide a delay timer that prevents a STA 120 from transmitting for a certain amount of time after each successful UL-MU-MIMO TXOP or after each RTX, RTS, PS-poll, or QoS null frame. The timer can be restarted after each successful UL-MU-MIMO TXOP. In one aspect, the AP 110 can indicate the delay timer to STAs 120 in the setup phase or the delay timer can be different for each STA 120. In another aspect, the AP 110 can indicate the delay timer in the CTX message 402 or the delay timer can be dependent on the order of the STAs 120 in the CTX message 402, and can be different for each terminal.

In another operational mode, the AP 110 can indicate a time interval during which the STAs 120 are allowed to transmit a UL-MU-MIMO transmission. In one aspect, the AP 110 indicates a time interval to the STAs 120 during which the STA are allowed to send a RTX or RTS or other request to the AP 110 to ask for an UL-MU-MIMO transmission. In this aspect, the STAs 120 can use regular contention protocol. In another aspect, the STA may not initiate a UL-MU-MIMO transmission during the time interval but the AP 110 can send a CTX or other message to the STA to initiate the UL-MU-MIMO transmission.

In certain embodiments, a STA 120 enabled for UL-MU-MIMO can indicate to an AP 110 that it requests an UL-MU-MIMO TXOP because it has data pending for UL. In one aspect, the STA 120 can send a RTS or a PS-poll to request a UL-MU-MIMO TXOP. In another embodiment, the STA 120 can send any data frame, including a quality of service (QoS) null data frame, where the bits 8-15 of the QoS control field indicate a non-empty queue. In this embodiment the STA 120 can determine during the setup phase which data frames (e.g., RTS, PS-poll, QoS null, etc.) will trigger a UL-MU-MIMO transmission when the bits 8-15 of the QoS control field indicate a non-empty queue. In one embodiment, the RTS, PS-poll, or QoS null frames can include a 1 bit indication allowing or disallowing the AP 110 to respond with a CTX message 402. In another embodiment, the QoS null frame can include TX power information and a per TID queue information. The TX power information and per TID queue information can be inserted in the two bytes of the sequence control and QoS controls fields in a QoS null frame and the modified QoS null frame can be sent to the AP 110 to request a UL-MU-MIMO TXOP. In another embodiment, referring to FIGS. 1 and 7, the STA 120 can send a RTX 701 to request a UL-MU-MIMO TXOP.

In response to receiving an RTS, RTX, PS-poll or QoS null frame, or other trigger message as described above, an AP 110 can send a CTX message 402. In one embodiment, referring to FIG. 7, after the transmission of the CTX message 402 and the completion of the UL-MU-MIMO transmissions 410A and 410B, TXOP returns to the STAs 120A and 120B which can decide on how to use the remaining TXOP. In another embodiment, referring to FIG. 7, after the transmission of the CTX message 402 and the completion of the UL-MU-MIMO transmissions 410A and 410B, TXOP remains with the AP 110 and the AP110 can use the remaining TXOP for additional UL-MU-MIMO transmissions by sending another CTX message 402 to either STAs 120A and 120B or to other STAs.

FIG. 8 is a diagram of one embodiment of a RTX frame 800. The RTX frame 800 includes a frame control (FC) field 810, a duration field 815 (optional), a transmitter address (TA)/allocation identifier (AID) field 820, a receiver address (RA)/basic service set identifier (BSSID) field 825, a TID field 830, an estimated transmission (TX) time field 850, and a TX power field 870. The FC field 810 indicates a control subtype or an extension subtype. The duration field 815 indicates to any receiver of the RTX frame 800 to set the network allocation vector (NAV). In one aspect, the RTX frame 800 may not have a duration field 815. The TA/AID field 820 indicates the source address which can be an AID or a full MAC address. The RA/BSSID field 825 indicates the RA or BSSID. In one aspect the RTX frame may not contain a RA/BSSID field 825. The TID field 830 indicates the access category (AC) for which the user has data. The Estimated TX time field 850 indicates the time requested for the UL-TXOP and can be the time required for a STA 120 to send all the data in its buffer at the current planned MCS. The TX power field 870 indicates the power at which the frame is being transmitted and can be used by the AP to estimate the link quality and adapt the power backoff indication in a CTX frame.

FIG. 9 is a diagram of another embodiment of a RTX 801 frame. In this embodiment, the RTX 801 frame contains a TID field and an Estimated TX time field for each access class listed in the RTX 801 frame (TID fields 831 and 840 and Estimated TX time fields 851, 860).

Before an UL-MU-MIMO communication can take place, an AP 110 collects information from the STAs 120 that can participate in the UL-MU-MIMO communication. An AP 110 can optimize the collection of information from the STAs 120 by scheduling the transmissions from the STAs 120.

In one embodiment, an AP 110 can use a station scheduling frame (SSF) to schedule the transmission of multiple station information frames (SIFs) from STAs 120. The SSF frame can be a short frame to allow for faster communication to trigger a response from the STA. The SSF can be a CTX message 402 or another message indicating the STAs 120 send a SIF. The SIF contains information indicating that the STAs 120 have data, how much data they have, and what type of data (i.e., what access class). It can also include the transmit power that is being used to send that SIF. In one embodiment, the SIF is a null data packet (NDP).

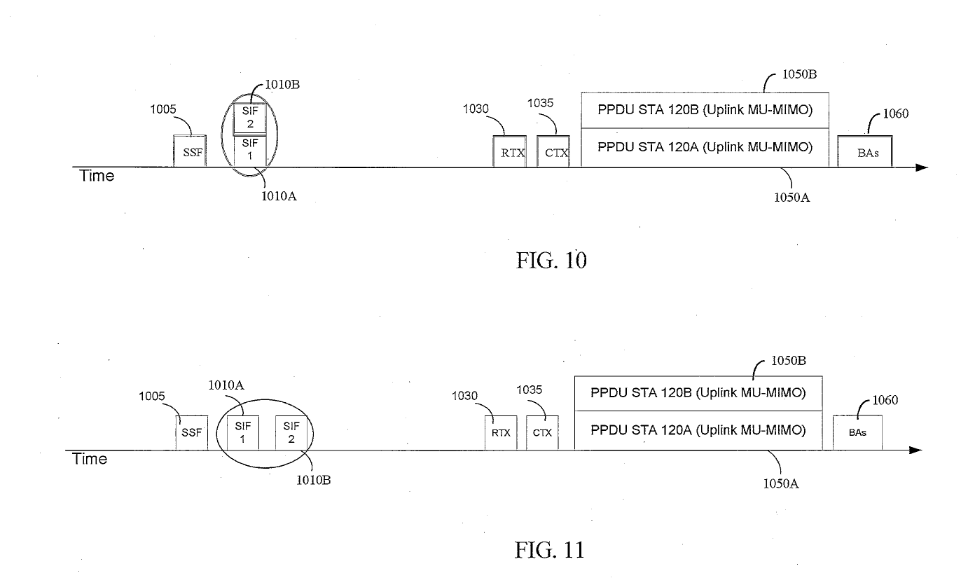

The SIF/SSF exchange can be optimized by using a TDMA, FDMA, SDMA, OFDMA, UL-MU-MIMO, or any other communication system that is based on an orthogonal multiplexing scheme. FIG. 10 is a time sequence diagram illustrating an example of a SSF/SIF exchange in a FDMA system. In this embodiment, the SSF 1005 contains a list of STAs 120 to send SIFs 1010A-1010B to an AP 110. The SSF 1005 can also contain power adjustment information to control the power of the FDMA transmission signals for the SIFs 1010. The SIFs 1010A and 1010B as well as the maximum number of TID information blocks allowed in a SIF 1010 can be pre-negotiated so that the SIF response is always a fixed time duration. Alternatively the amount of time for the SIF 1010 response can be pre-negotiated. The amount of time for the SIF 1010 response can also be included in the SSF 1005. When the response time is known, the STAs 120 would be allowed to send at higher MCSs and therefore send more TIDs. The frequency allocation based on the STA 120 order in the SSF can also be pre-negotiated to determine which STA 120 gets which 20 MHz block for communication.

FIG. 11 is a time sequence diagram illustrating an example of a SSF/SIF exchange in a TDMA system. In this embodiment, the SSF 1005 contains a list of STAs 120 to send SIFs 1010A-1010B to an AP 110. In this embodiment, SIFs 1010A and 1010B are sent sequentially by the STAs 120A and 120B, respectively. The MCS of the SIFs 1010A and 1010B, as well as the maximum number of TIDs allowed in a SIF 1010 can be pre-negotiated to determine the time of each SIF 1010. For example, if a STA 120 has less than the maximum number of TIDs to fill out, the STA 120 can fill the remaining TIDs with padding so that all the SIFs are the same length. Alternatively the amount of time for the SIF 1010 response can be pre-negotiated. The amount of time for the SIF 1010 response can also be included in the SSF 1005. When the response time is known, the STAs 120 would be allowed to send at higher MCSs and therefore send more TID information blocks.

In another embodiment, the SSF/SIF exchange can take place in OFDMA system. In this embodiment, the SSF 1005 contains the total number of STAs 120 being asked to send SIFs 1010A-1010B and a list of STAs 120 to send SIFs 1010A-1010B to an AP 110. The SSF 1005 can also contain power adjustment information to control the power of the SIF 1010 signals. In this embodiment, the MCS of the SIFs 1010A-1010B, and number of TID information blocks in the SIF 1010 can be pre-negotiated. Alternatively, the amount of time for the SIF 1010 response can also be included in the SSF 1005 or pre-negotiated. When the response time is known by the STAs 120, the STAs 120 would be allowed to send at higher MCSs and therefore send more TIDs. In one aspect, the mapping of the STAs 120 order to subcarriers can be pre-negotiated and would be a function of the number of STAs 120 being asked to send a SIF 1010.

In another embodiment, the SSF/SIF exchange can take place in a UL-MU-MIMO system. In this embodiment, the SSF 1005 contains a list of STAs 120 to send SIFs 1010A-1010B to an AP 110. The SSF 1005 can also contain power adjustment information to control the power of the SIF 1010 signals. In this embodiment, the MCS of the SIFs 1010A-1010B can be pre-negotiated. In one aspect, the mapping of the STAs 120 order to spatial streams can be pre-negotiated and would be a function of the number of STAs 120 being asked to send a SIF 1010. Additionally, the maximum number of TIDs allowed in a SIF 1010 and the amount of time for the SIF 1010 response can be pre-negotiated. Alternatively, the amount of time for the SIF 1010 response can also be included in the SIF 1010, or pre-negotiated. When the response time is known by the STAs 120, the STAs 120 would be allowed to send at higher MCSs and therefore send more TIDs.

As discussed above, the CTX message 402 can be used in a variety of communications. FIG. 12 is a diagram of an example of a CTX frame 1200 structure. In this embodiment, the CTX frame 1200 is a control frame that includes a frame control (FC) field 1205, a duration field 1210, a transmitter address (TA) field 1215, a control (CTRL) field 1220, a PPDU duration field 1225, a STA info field 1230, and a frame check sequence (FCS) field 1280. The FC field 1205 indicates a control subtype or an extension subtype. The duration field 1210 indicates to any receiver of the CTX frame 1200 to set the network allocation vector (NAV). The TA field 1215 indicates the transmitter address or a BSSID. The CTRL field 1220 is a generic field that can include information regarding the format of the remaining portion of the frame (e.g., the number of STA info fields and the presence or absence of any subfields within a STA info field), indications for rate adaptation for the STAs 120, indication of allowed TID, and indication that a CTS must be sent immediately following the CTX frame 1200. The CTRL field 1220 can also indicate if the CTX frame 1200 is being used for UL MU MIMO or for UL FDMA or both, indicating whether a Nss or Tone allocation field is present in the STA Info field 1230. Alternatively, the indication of whether the CTX is for UL MU MIMO or for UL FDMA can be based on the value of the subtype. Note that UL MU MIMO and UL FDMA operations can be jointly performed by specifying to a STA both the spatial streams to be used and the channel to be used, in which case both fields are present in the CTX; in this case, the Nss indication is referred to a specific tone allocation. The PPDU duration field 1225 indicates the duration of the following UL-MU-MIMO PPDU that the STAs 120 are allowed to send. The STA Info field 1230 contains information regarding a particular STA and can include a per-STA (per STA 120) set of information (see first STA info field 1230 and Nth STA Info 1275). The first STA info230 field can include an AID or MAC address field 1232 which identifies a STA, a number of spatial streams field (Nss) 1234 field which indicates the number of spatial streams a STA can use (in an UL-MU-MIMO system), a Time Adjustment 1236 field which indicates a time that a STA should adjust its transmission compared to reception of a trigger message (the CTX in this case), a Power Adjustment 1238 field which indicates a power backoff a STA should take from a declared transmit power, a Tone Allocation 1240 field which indicates the tones or frequencies a STA can use (in a UL-FDMA system), an Allowed TID 1242 field which indicates the allowable TID, an Allowed TX Mode 1244 field which indicates the allowed TX modes, and a MCS 1246 field which indicates the MCS the STA should use. A STA 120 receiving a CTX with a Allowed TID 1242 indication can be allowed to transmit data only of that TID, data of the same or higher TID, data of the same or lower TID, any data, or only data of that TID first, then if no data is available, data of other TIDs. The FCS field 1280 indicates the carries an FCS value used for error detection of the CTX frame 1200.

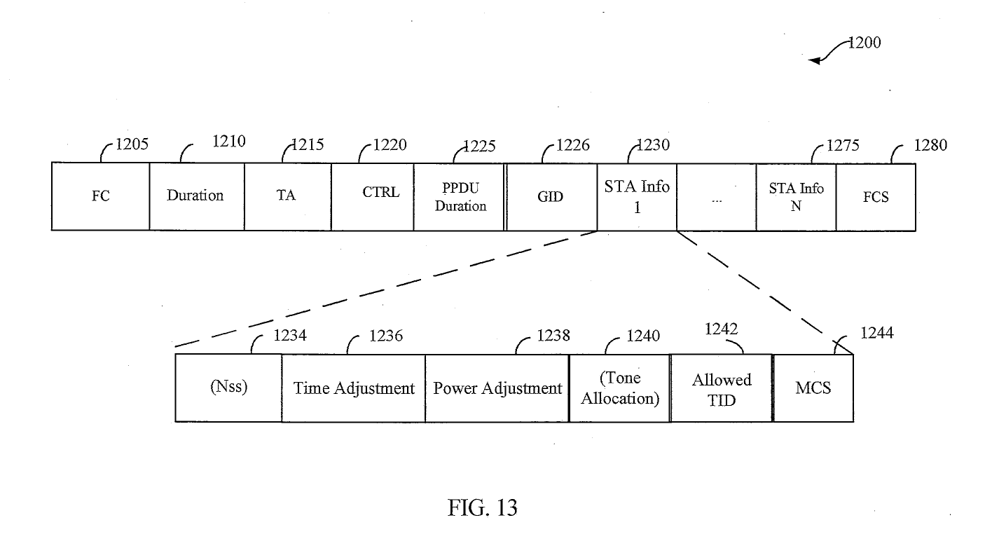

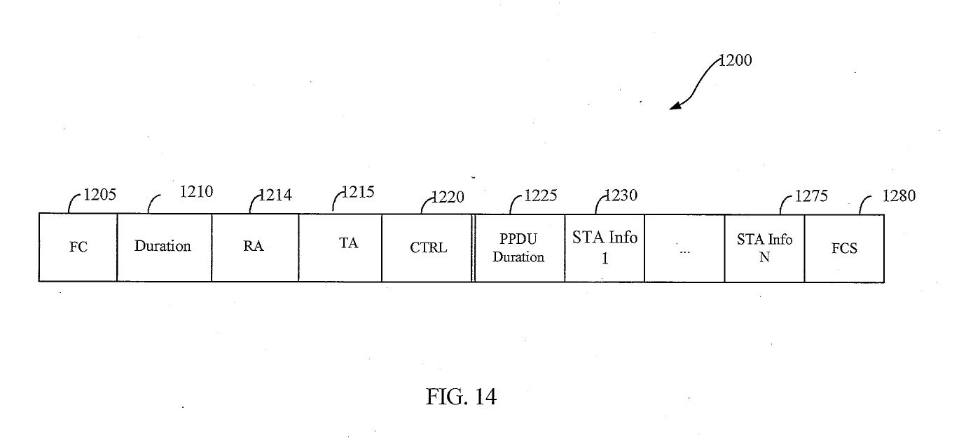

FIG. 13 is a diagram of another example of a CTX frame 1200 structure. In this embodiment and in conjunction with FIG. 12, the first STA info230 field does not contain the AID or MAC Address field 1232 and instead the CTX frame 1200 includes a group identifier (GID) 1226 field which identifies the STAs by a group identifier rather than an individual identifier. FIG. 14 is a diagram of another example of a CTX frame 1200 structure. In this embodiment and in conjunction with FIG. 13, the GID 1226 field is replaced with a RA 1214 field which identifies a group of STAs through a multicast MAC address.

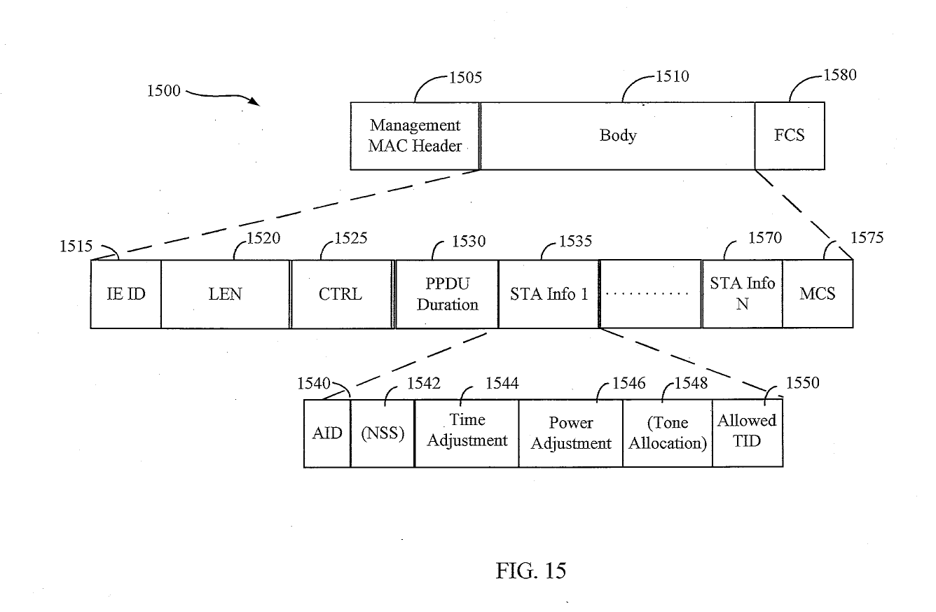

FIG. 15 is a diagram of an example of a CTX frame 1500 structure. In this embodiment, the CTX frame 1500 is a management frame that includes a Management MAC Header 1505 field, a Body 1510 field, and a FCS 1580 field. The Body 1510 field includes an IE ID 1515 field which identifies an information element (IE), a LEN 1520 field which indicates the length of the CTX frame 1500, a CTRL 1525 field which includes the same information as the CTRL field 1220, a PPDU Duration 1530 field which indicates the duration of the following UL-MU-MIMO PPDU that the STAs 120 are allowed to send, a first STA info 1535 field and a MCS 1575 field which can indicate the MCS for all the STAs to use in the following UL-MU-MIMO transmission, or an MCS backoff for all the STAs to use in the following UL-MU-MIMO transmission. The first STA info 1535 (along with Nth STA Info 1570) field represent a per STA field that includes AID 1540 field which identifies a STA, a number of spatial streams field (Nss) 1542 field which indicates the number of spatial streams a STA can use (in an UL-MU-MIMO system), a Time Adjustment 1544 field which indicates a time that a STA should adjust its transmission compared to reception of a trigger message (the CTX in this case), a Power Adjustment 1546 field which indicates a power backoff a STA should take from a declared transmit power, a Tone Allocation 1548 field which indicates the tones or frequencies a STA can use (in a UL-FDMA system), and an Allowed TID 1550 field which indicates the allowable TID.

In one embodiment, the CTX frame 1200 or the CTX frame 1500 can be aggregated in an A-MPDU to provide time to a STA 120 for processing before transmitting the UL signals. In this embodiment, padding or data can be added after the CTX to allow a STA 120 additional time to process the forthcoming packet. One benefit to padding a CTX frame can be to avoid possible contention issues for the UL signals from other STAs 120. In one aspect, if the CTX is a management frame, additional padding IEs can be sent. In another aspect the STAs 120 can request to an AP 110 a minimum duration or padding for the CTX frame.

In some embodiments, an AP 110 can initiate a CTX transmission. In one embodiment, an AP 110 can send a CTX message 402 in accordance with regular enhanced distribution channel access (EDCA) contention protocol. In another embodiment, an AP 110 can send a CTX message 402 at scheduled times. In this embodiment, the scheduled times can be indicated by the AP 110 to the STAs 120 by using a restricted access window (RAW) indication in a beacon which indicates a time reserved for a group of STAs 120 to access the medium, a target wake time (TWT) agreement with each STA 120 which indicates to multiple STAs 120 to be awake at the same time to take part in a UL-MU-MIMO transmission, or information in other fields. Outside the RAW and TWT a STA 102 can be allowed to transmit any frame, or only a subset of frames (e.g., non-data frames). It can also be forbidden to transmit certain frames (e.g., it can be forbidden to transmit data frames). The STA 120 can also indicate that it is in sleep state. One advantage to scheduling a CTX is that multiple STAs 120 can be indicated a same TWT or RAW time and can receive a transmission from an AP 110.

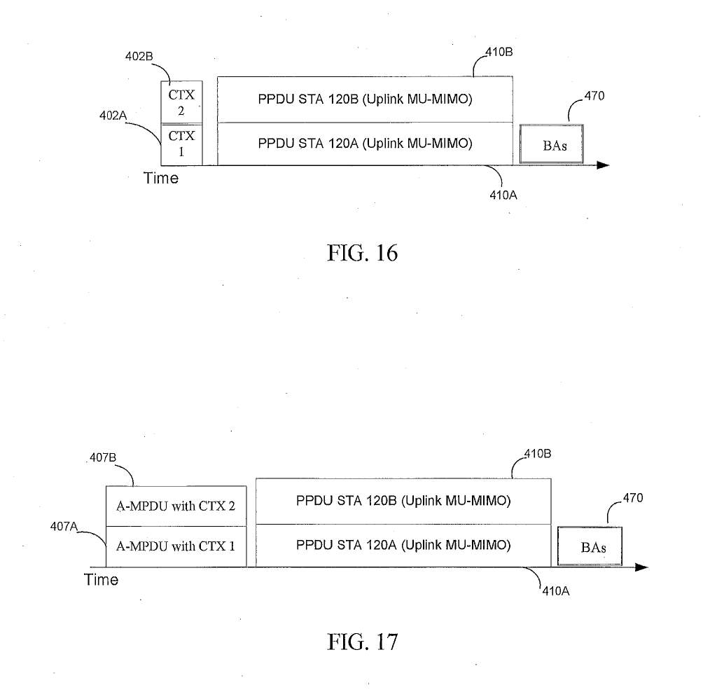

In one embodiment, a CTX message 402 can include information for a single STA 120. In this embodiment, an AP 110 can send multiple CTX messages 402 that include information for one STA 120 at the same time to multiple STAs 120, creating a schedule for the following UL-MU-MIMO transmission 410. FIG. 16 is a time sequence diagram illustrating an example of sending multiple CTX messages 402A and 402 B at the same time. As shown, the CTX messages 402A and 402B can be sent simultaneously using DL-MU-MIMO or DL-FDMA transmissions to one station each (STA 120A and 120B, respectively). The STAs 120A and 120B receive the CTX messages 402A and 402B and then begin the UL-MU-MIMO (or UL-FDMA) transmissions 410A and 410B. FIG. 17 is a time sequence diagram and illustrates an example of sending the CTX messages within A-MPDU messages 407A and 407B. As in FIG. 16, the CTX portion of the A-MPDU messages 407A and 407B contain information for one STA (STA 120A and 120B, respectively) and the STAs 120A and 120B receive the A-MPDU messages 407A and 407B and begin the UL-MU-MIMO (or UL-FDMA) transmissions 410A and 410B.

In other embodiments, a STA 120 may not start an UL transmission after receiving a CTX message 402. In one embodiment an AP 110 defines a new frame that triggers a UL transmission. The new frame can be any frame indicated by an AP 110 and can comprise a NDP frame. In this embodiment, the new frame can include a sequence or token number that links the frame to the CTX so that the STA knows that the frame is the same trigger message as indicated in the CTX and can begin an UL transmission. The frame can also include a duration so that other STAs 120 hearing the transmission can set their NAV. The STA 120 can acknowledge receipt of the CTX by sending an ACK or similar frame. In another embodiment a STA 120 can request the use of a trigger message. The request can indicate that the trigger be immediate or delayed. One benefit of having a separate trigger message can be that the trigger message can give a STA more time to process the CTX before an UL transmission. Another benefit can be that the trigger message can be a shorter frame than the CTX and can be sent at multiple times without subsequent CTX messages to allow for faster UL time. The trigger could frame could follow the CTX immediately, or at a pre-specified offset or set of offsets from the CTX.

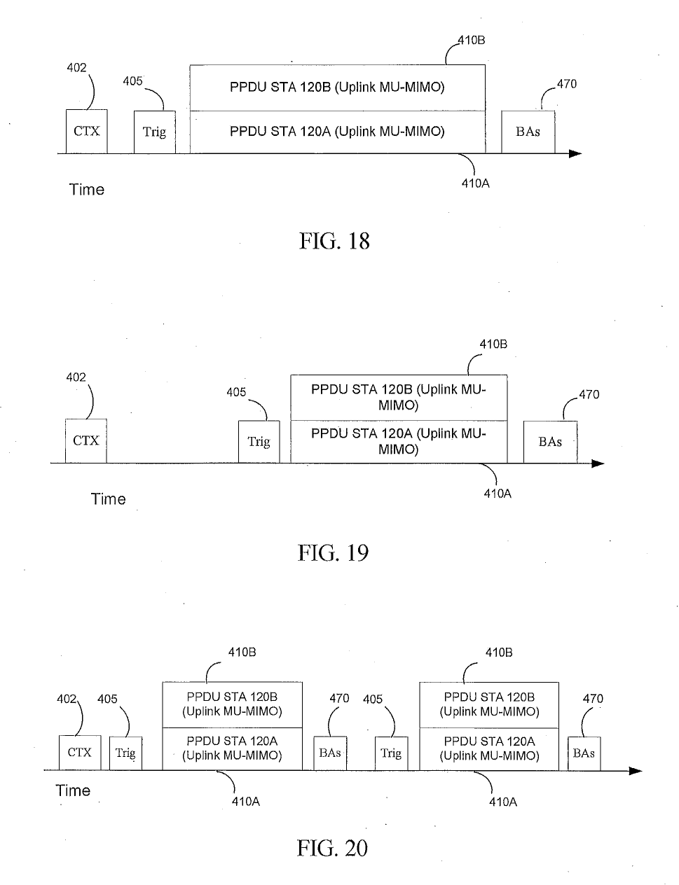

FIG. 18 is a time sequence diagram that illustrates one embodiment of a CTX/Trigger exchange. In this embodiment, an AP 110 sends a CTX message 402 to the STAs 120 and then later sends the trigger message 405. Once the STAs 120A and 120B receive the trigger message 405, they begin the UL-MU-MIMO transmissions 410A and 410B. FIG. 19 is a time sequence diagrams that illustrates an example where the time between the CTX message 402 and the trigger message 405 is greater than that shown in FIG. 18. FIG. 20 is a time sequence diagram that illustrates an example of sending multiple trigger messages 405 over time to initiate multiple UL-MU-MIMO 4010 transmissions. In this embodiment, the second trigger message 405 does not need to be preceded by the CTX message 402 to initiate the second UL-MU-MIMO transmissions 410A and 410B because the STAs 120A and 120B can just confirm the trigger message has the same sequence or token number as indicated in the CTX and begin transmission.

In some embodiments, if an AP 110 cannot multiplex ACKs or BAs to STAs 120 (i.e., an AP 110 is not using any DL-MU-MIMO or DL-FDMA to send ACKs to multiple STA at the same time), then only one STA 120 can be allowed to set the BA policy to an immediate BA or a normal ACK and the AP 110 can be allowed to indicate which STA 120 in the CTX list can set the BA policy. The indication can be based on the position of the STA info field for that STA 120 in the CTX, such as the first position.

In another embodiment, if an AP 110 can multiplex ACKs or BAs to STAs 120, then more than one STA 120 can set the BA policy to immediate BA or normal ACK. In this embodiment, the AP 110 will use DL-MU-MIMO or DL-FDMA to send immediate ACKs to the multiple STAs 120 that indicated immediate BA or normal ACK at the same time. In a different embodiment, if a STA sets the BA policy to Delayed BA, then the AP 110 can send the BAs in a time sequence to the STAs 120. The time sequence can be separated by SIFS. In another embodiment, if a STA 120 sets the BA policy to BA, the AP 110 will wait for a poll from each STA 120 before sending a BA. In another embodiment, a broadcast BA frame can be defined, which includes block acknowledgments for multiple STAs 120. In case such a frame is used, multiple STAs 120 are allowed to set the ACK policy to immediate BA; the STAs 120 that set the ACK policy to immediate BA are acknowledged by the inclusion of the corresponding block acknowledgment in the broadcast BA frame sent immediately after the UL transmissions. The broadcast BA can also be used to acknowledge multiple STAs 120 that set a delayed BA policy; in this case the broadcast BA frame is sent with contention at a later time.

As discussed above, for example with respect to FIG. 6, in various embodiments, the AP 110 can convey a time T for the STAs 120 to begin UL-MU-MIMO transmissions 410A. In various embodiments, transmissions from the STAs 120 can take different amounts of time to reach the AP 110. For example, the STAs 120 can be various distances from the AP 110, transmissions can take different length paths to the AP 110, can travel through different wireless media, etc. Accordingly, in various embodiments, the AP 110 can measure the differences in transmission travel time, and can instruct the STAs 120 to correct for this difference. In various embodiments, the AP 110 can indicate a timing offset or minimum and maximum time adjustment, a group-basis and/or per-STA basis. For example, the AP 110 can include the timing offset in the CTX message 402.

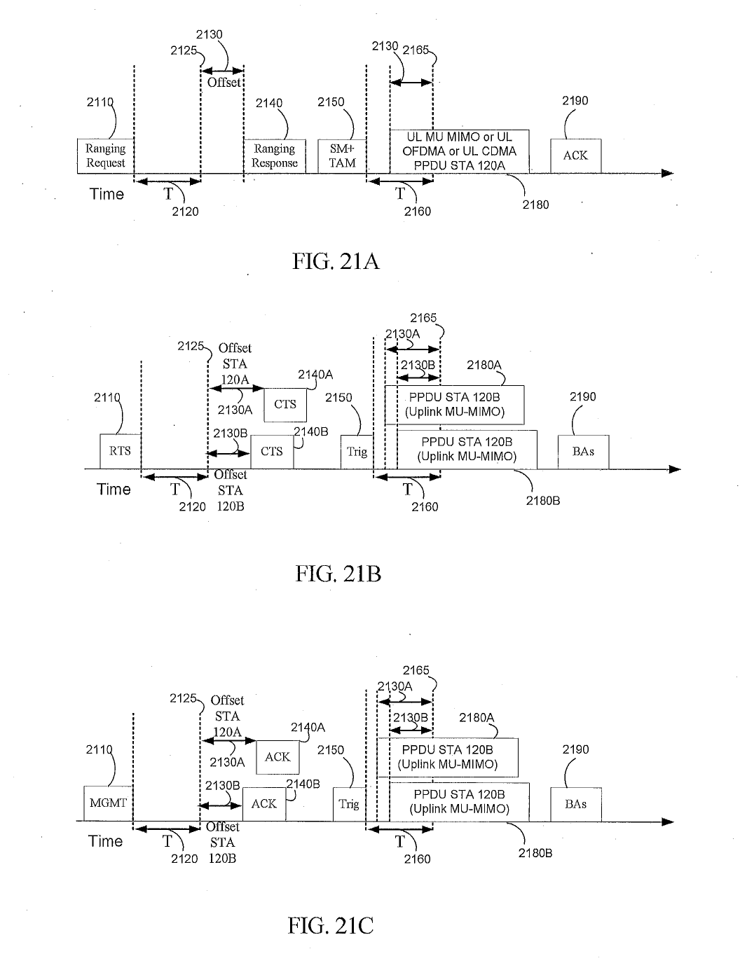

FIGS. 21A-21C show time sequence diagrams that illustrate various embodiments of timing offset exchanges. A person having ordinary skill in the art will appreciate that the illustrated timing offset exchanges can include additional transmissions and/or fields, transmissions and/or fields can be rearranged, removed, and/or resized, and the contents of the transmissions and/or fields varied. For example, in various embodiments, the timing offset exchanges can variously include SU transmissions, MU transmissions, or a combination of SU and MU transmissions.

As shown in FIG. 21A, the AP 110 can transmit a ranging request message 2110 to the STA 120A. In various embodiments, the ranging request message 2110 can be included in one or more messages discussed herein. For example, the ranging request message 2110 can include an RTS frame. The ranging request message 2110 can request or instruct that the STA 120A transmit a ranging response message 2140 at a reference time 2125.

In the illustrated embodiment, the reference time 2125 can be based on the transmission of the ranging request message 2110. For example, the reference time 2125 can be a time interval 2120 after the end of the ranging request message 2110. In various embodiments, the time interval 2120 can be a SIFS or PIFS. In some embodiments, the AP 110 and the STA 120A can negotiate or prearrange the value of the time interval 2120 in advance. In some embodiments, the time interval 2120 can be preset or stored in a memory.

Referring still to FIG. 21A, the STA 120A can transmit the ranging response message 2140 at the reference time 2125. In various embodiments, the ranging response message 2140 can be included in one or more messages discussed herein. For example, the ranging response message 2140 can include a CTS frame. Although the STA 120A can begin transmission of the ranging response message 2140 at the reference time 2125, the AP 110 might not receive the ranging response message 2140 until an offset time 2130 after the reference time 2125. Although the ranging response message 2140 is shown as being received by the AP 110 the offset time 2130 after the reference time 2125, a person having skill in the art will appreciate that, from the perspective of the STA 120A, the ranging response message 2140 is transmitted at the reference time 2125 without offset.

The AP 110 can measure a difference between the reference time 2125, and the time at which the ranging response message 2140 is received, to determine the offset time 2130. In various embodiments, the AP 110 can store the offset time 2130 in a memory. In some embodiments, the AP 110 can compute a timing adjustment based on the ranging information from one or more STAs, and can store a plurality of adjustments in a memory.

The AP 110 can instruct the STA 120A to advance its transmission timing by the offset time 2130. For example, in the illustrated embodiment, the AP 110 can transmit a combined scheduling message and timing adjustment message (SM+TAM) (for example, trigger message 2150) instructing the STA 120A to transmit an PPDU 2180 UL frame at a reference transmission time 2165, adjusted by the offset time 2130. Although the SM+TAM trigger message 2150 is shown as a combined frame, in various embodiments, the SM and TAM can be separate. In various embodiments, SM+TAM frame can include any UL initiation and/or scheduling frame discussed herein such as, for example, the CTX message 402 (FIG. 4), the SSF 1005 (FIG. 10), the A-MPDU messages 407A-407B (FIG. 17) or an A-PPDU, the acknowledgement 470 (FIG. 18), the trigger message 405 (FIG. 18), etc. The AP 110 can include the adjustment information or offset time 2130 in the trigger message 2150 in a field such as, for example, the time adjustment field 1236 (FIG. 12) or 1544 (FIG. 15), or any other field. The trigger message 2150 can trigger any UL transmission discussed herein such as, for example, the UL-MU-MIMO transmission 410 (FIG. 4) PPDU, the CTS 408 (FIG. 4), the SIF 1010 (FIG. 10), an acknowledgement, etc.

The STA 120A can receive the trigger message 2150, and can determine the offset time 2130, for example by decoding the time adjustment field 1236 (FIG. 12). The STA 120A can advance or otherwise adjust transmission timing based on the offset time 2130. For example, in the illustrated embodiment, the STA 120A advances transmission of the PPDU 2180, from the reference transmission time 2165, by the offset time 2130. Although the PPDU 2180 is shown as being transmitted by the STA 120A at the offset time 2130 before the reference transmission time 2165, a person having skill in the art will appreciate that, from the perspective of the AP 110, the PPDU 2180 is received at the reference time, or substantially at the reference transmission time 2165 without offset.

In various embodiments, the reference transmission time 2165 can be based on the transmission of the trigger message 2150. For example, the reference transmission time 2165 can be a time interval 2160 after the end of the trigger message 2150. In various embodiments, the time interval 2160 can be a SIFS or PIFS. In some embodiments, the AP 110 and the STA 120A can negotiate or prearrange the value of the time interval 2160 in advance. In some embodiments, the time interval 2160 can be preset or stored in a memory.

After receiving the PPDU 2180 from the STA 120A, the AP 110 can transmit an acknowledgement 2190. Although FIG. 21A shows a single-user embodiment, the concepts discussed herein can be used in multi-user environments, such as with the UL-MU-MIMO embodiments discussed herein. FIG. 21B shows an exemplary timing offset exchange in an UL-MU-MIMO embodiment. Although FIGS. 21B-21C show specific exemplary message types, such as the ranging request message 2110 (e.g., RTS), response message 2140 (e.g., CTS), etc., a person having ordinary skill in the art will appreciate that other suitable messages can be used as discussed herein.

As shown in FIG. 21B, the AP 110 can transmit a ranging request message 2110 to the STAs 120A and 120B. In various embodiments, the ranging request message 2110 can be included in one or more messages discussed herein. For example, the ranging request message 2110 can include an RTS frame. The ranging request message 2110 can request or instruct that the STAs 120A and 120B transmit a ranging response messages 2140A and 2140B at a reference time 2125.

In the illustrated embodiment, the reference time 2125 can be based on the transmission of the ranging request message 2110. For example, the reference time 2125 can be a time interval 2120 after the end of the ranging request message 2110. In various embodiments, the time interval 2120 can be a SIFS or PIFS. In some embodiments, the AP 110 and the STAs 120A and 120B can negotiate or prearrange the value of the time interval 2120 in advance. In some embodiments, the time interval 2120 can be preset or stored in a memory.

Referring still to FIG. 21B, the STAs 120A and 120B can transmit the ranging response messages 2140A and 2140B at the reference time 2125. In various embodiments, the ranging response messages 2140A and 2140B can be included in one or more messages discussed herein. For example, the ranging response messages 2140A and 2140B can include CTS frames. Although the STAs 120A and 120B can each begin transmission of the ranging response messages 2140A and 2140B at the reference time 2125, the AP 110 might not receive the ranging response message 2140A until a first offset time 2130A after the reference time 2125, and might not receive the ranging response messages 2140A and 2140B until a second offset time 2130B after the reference time 2125. Although the ranging response messages 2140A and 2140B is shown as being received by the AP 110 the offset times 2130A and 2130B after the reference time 2125, a person having skill in the art will appreciate that, from the perspective of the STAs 120A and 120B, the ranging response messages 2140A and 2140B are each transmitted at the reference time 2125 without offset.

The AP 110 can measure a difference between the reference time 2125, and the time at which the ranging response messages 2140A and 2140B are received, to determine the offset times 2130A and 2130B for each STA 120. In various embodiments, the AP 110 can store the offsets 2130A and 2130B in a memory, and each offset can be associated with an individual STA or a group of STAs with similar offsets (for example, within a threshold value of each other). In some embodiments, the AP 110 can compute a timing adjustment based on the ranging information from one or more STAs, and can store a plurality of adjustments in a memory.

The AP 110 can instruct the STAs 120A and 120B to advance their transmission timing by the offset times 2130A and 2130B. For example, in the illustrated embodiment, the AP 110 can transmit a trigger message 2150 instructing the STAs 120A and 120B to transmit an uplink message (e.g., PPDU 2180B) at a reference transmission time 2165, adjusted by the offset times 2130A and 2130B, respectively. In various embodiments, the trigger message 2150 can include any UL initiation frame discussed herein such as, for example, the CTX message 402 (FIG. 4), the SSF 1005 (FIG. 10), the A-MPDU messages 407A-407B (FIG. 17) or an A-PPDU, the acknowledgement 470 (FIG. 18), the trigger message 405 (FIG. 18), etc. The AP 110 can include the adjustment information or offset time 2130B in the trigger message 2150 in a field such as, for example, the time adjustment field 1236 (FIG. 12) or 1544 (FIG. 15), or any other field. The trigger message 2150 can trigger any UL transmission discussed herein such as, for example, the UL-MU-MIMO transmission 410 (FIG. 4) PPDU, the CTS 408 (FIG. 4), the SIF 1010 (FIG. 10), an acknowledgement, etc.

The STAs 120A and 120B can receive the trigger message 2150, and can determine the offset times 2130A and 2130B, respectively, for example by decoding the time adjustment field 1236 (FIG. 12). The STAs 120A and 120B can advance or otherwise adjust transmission timing based on the offset times 2130A and 2130B, respectively. For example, in the illustrated embodiment, the STAs 120A and 120B advance transmission of the PPDUs 2180A and 2180B, from the reference transmission time 2165, by the offset times 2130A and 2130B, respectively. Although the PPDUs 2180A and 2180B are shown as being transmitted by the STAs 120A and 120B at the offset times 2130A and 2130B before the reference transmission time 2165, a person having skill in the art will appreciate that, from the perspective of the AP 110, the PPDUs 2180A and 2180B are received at the reference time, or substantially at the reference time, 2165 without offset.

In various embodiments, the reference transmission time 2165 can be based on the transmission of the trigger message 2150. For example, the reference transmission time 2165 can be a time interval 2160 after the end of the trigger message 2150. In various embodiments, the time interval 2160 can be a SIFS or PIFS. In some embodiments, the AP 110 and the STAs 120A and 120B can negotiate or prearrange the value of the time interval 2160 in advance. In some embodiments, the time interval 2160 can be preset or stored in a memory.

After receiving the PPDUs 2180A and 2180B from the STAs 120A and 120B, the AP 110 can transmit an acknowledgement 2190, which can include a block acknowledgement. Although FIGS. 21A and 21B show the ranging request message 2110 as an RTS, and the ranging response message 2120 as a CTS, a person having ordinary skill in the art will appreciate that the ranging request message can include any frame or message discussed herein or otherwise suitable. In one embodiment, for example, the ranging request message 2110 can include a management frame. The ranging response message can include an acknowledgement of the management frame. FIG. 21C shows a time sequence diagram of a timing offset exchange using management frames and acknowledgements.

FIG. 22 shows a flowchart 2200 for an exemplary method of wireless communication that can be employed within the wireless communication system 100 of FIG. 1. The method can be implemented in whole or in part by the devices described herein, such as the AP 110 (FIG. 1), any of the STAs 120 (FIG. 1), and the wireless device 302 shown in FIG. 3. Although the illustrated method is described herein with reference to the wireless communication system 100 discussed above with respect to FIG. 1, the wireless device 302 discussed above with respect to FIG. 3, and the frames and frame exchanges of FIGS. 4-21, a person having ordinary skill in the art will appreciate that the illustrated method can be implemented by another device described herein, or any other suitable device. Although the illustrated method is described herein with reference to a particular order, in various embodiments, blocks herein can be performed in a different order, or omitted, and additional blocks can be added.

First, at block 2210, an access point receives ranging information from a plurality of wireless devices. For example, the AP 110 can receive the ranging response messages 2140A and 2140B from the STAs 120A and 120B. The ranging response message 2140 can be in response to, for example, the ranging request message 2110.

Next, at block 2220, the access point determines a timing adjustment, for each of the plurality of wireless devices, based on the ranging information. For example, the AP 110 can subtract the reference time 2125 from the receipt time of the ranging response messages 2140A and 2140B, to determine the offset times 2130A and 2130B. In various embodiments, the timing adjustments can be equal to the offset times 2130A and 2130B (positive or negative).

Then, at block 2230, the access point transmits a timing adjustment message to each wireless device, the timing adjustment message indicating the timing adjustment. For example, the AP 110 can transmit the trigger message 2150. In various embodiments, the timing adjustment message can be included in another frame separate from the trigger message 2150.

Thereafter, at block 2240, the access point transmits a scheduling message instructing the plurality of wireless devices to transmit uplink data at a first reference time corrected by the timing adjustment. For example, the AP 110 can transmit the trigger message 2150. The trigger message 2150 can instruct the STAs 120A and 120B to initiate transmission of uplink messages such as PPDUs 2180A and 2180B.

In various embodiments, the timing adjustment message and the scheduling message include the same message. For example, both messages can be included in the trigger message 2150. In various embodiments, receiving the ranging information includes transmitting a ranging request message requesting a response from one or more of the plurality of wireless devices at a second reference time, receiving at least one response at an offset time, and measuring a time difference between the second reference time and the offset time. For example, the AP 110 can transmit the ranging request message 2110.

In various embodiments, the second reference time includes a time based on the transmission of the ranging request message. In various embodiments, the reference time includes a time occurring at a time interval after an end of transmission of the ranging request message. In various embodiments, the time interval includes a short interframe space (SIFS) or a point coordination function (PCF) interframe space (PIFS). In various embodiments, the time interval is agreed between at least one wireless device and the access point.

In various embodiments, measuring the time includes storing a measured time for each of one or more of the plurality of wireless devices. In various embodiments, the one or more wireless devices include a single wireless device. In various embodiments, the one or more wireless devices include more than one wireless device and the plurality of wireless devices each send the response at the reference time by using uplink multiple-user multiple-in-multiple-out (UL MU MIMO) or uplink orthogonal frequency division multiple access (UL OFDMA) or code division multiple access (CDMA) multiplexing.

In various embodiments, the ranging request message includes a request-to-send (RTS) message and the response includes a clear-to-send (CTS) message, and the time interval includes a short interframe space (SIFS). In various embodiments, the ranging request message includes a data or management frame and the response includes an acknowledgement (ACK) or block ACK (BA), and the time interval includes a short interframe space (SIFS). In various embodiments, the ranging request message includes a physical layer (PHY) header and no payload, the PHY header including one or more of an indication of the source address and the purpose or type of the message.

In various embodiments, the response message includes a physical layer (PHY) header and no payload, the PHY header including one or more of an indication of the source address and the purpose or type of the message. In various embodiments, the ranging request message includes the scheduling message and the response includes a clear-to-send (CTS) message, and the time interval includes a short interframe space (SIFS). In various embodiments, determining the timing adjustment includes calculating, for each of the plurality of wireless devices, a timing adjustment as a difference between a largest of timing measurements of the plurality of wireless devices and a timing measurement of each of the plurality of wireless devices.

In various embodiments, indicating the timing adjustment includes transmitting a control or management frame identifying one or more of the plurality of wireless devices and including the timing adjustment for each of the one or more of the plurality of wireless devices. In various embodiments, the scheduling message includes an indication that the transmission of each of the plurality of wireless devices is to be started at a time based on a reference start time and on the timing adjustment for each of the plurality of wireless devices. In various embodiments, the reference start time includes a short interframe space (SIFS) time after reception of the scheduling message.

In various embodiments, the reference start time includes a point coordination function (PCF) interframe space (PIFS) time after reception of the scheduling message. In various embodiments, the reference start time includes a time agreed between at least one wireless device and access point. In various embodiments, the method can further include adding to the reference start time the timing adjustment.

In various embodiments, the method can further include grouping the plurality of wireless devices such that the timing adjustment is below a threshold value difference among wireless devices in each group. In various embodiments, transmitting the scheduling message includes indicating that the transmission of each of the plurality of wireless devices is to be started at a time based on a reference start time and no timing adjustment.

FIG. 23 shows a flowchart 2300 for another exemplary method of wireless communication that can be employed within the wireless communication system 100 of FIG. 1. The method can be implemented in whole or in part by the devices described herein, such as the AP 110 (FIG. 1), any of the STAs 120 (FIG. 1), and the wireless device 302 shown in FIG. 3. Although the illustrated method is described herein with reference to the wireless communication system 100 discussed above with respect to FIG. 1, the wireless device 302 discussed above with respect to FIG. 3, and the frames and frame exchanges of FIGS. 4-21, a person having ordinary skill in the art will appreciate that the illustrated method can be implemented by another device described herein, or any other suitable device. Although the illustrated method is described herein with reference to a particular order, in various embodiments, blocks herein can be performed in a different order, or omitted, and additional blocks can be added.

First, at block 2310, a wireless device transmits ranging information for the wireless device. For example, the STA 120A can transmit the ranging response message 2140 to the AP 110. The STA 120A can transmit the ranging response message 2140 in response to receiving the ranging request message 2110.

Next, at block 2320, the wireless device receives, from an access point, a timing adjustment message indicating a timing adjustment. For example, the STA 120A can receive the trigger message 2150 from the AP 110. In various embodiments, the timing adjustment message can be included in a frame separate from scheduling message 2150.

Then, at block 2330, the wireless device receives a scheduling message instructing transmission of uplink data at a first reference time corrected by the timing adjustment. For example, the STA 120A can receive the trigger message 2150 from the AP 110. The trigger message 2150 can instruct the STA 120 to transmit the PPDU 2180A.

Thereafter, at block 2340, the wireless device transmits uplink data at the reference time corrected by the timing adjustment. For example, the STA 120A can transmit the PPDU 2180A at the reference transmission time 2165 corrected by the offset time 2130A. The STA 120A can determine the reference transmission time 2165 and can subtract the offset time 2130A from the reference transmission time 2165 in order to determine a transmission start time.

In various embodiments, the timing adjustment message and the scheduling message include the same message. For example, both messages can be included in the trigger message 2150. In various embodiments, transmitting the ranging information can include receiving a ranging request message requesting a response from the wireless device at a reference time, and transmitting at least one response at an offset time. For example, the STA 120A can transmit the ranging response message 2140 after receiving the ranging request message 2110.

In various embodiments, the second reference time can include a time based on the transmission of the ranging request message. In various embodiments, the reference time can include a time occurring at a time interval after an end of transmission of the ranging request message. In various embodiments, the time interval can include a short interframe space (SIFS) or a point coordination function (PCF) interframe space (PIFS).

In various embodiments, the time interval is agreed between the wireless device and the access point. In various embodiments, the ranging request message can include a request-to-send (RTS) message and the response can include a clear-to-send (CTS) message, and the time interval can include a short interframe space (SIFS). In various embodiments, the ranging request message can include a data or management frame and the response can include an acknowledgement (ACK) or block ACK (BA), and the time interval can include a short interframe space (SIFS).

In various embodiments, the ranging request message can include a physical layer (PHY) header and no payload, the PHY header including one or more of an indication of the source address and the purpose or type of the message. In various embodiments, the response message can include a physical layer (PHY) header and no payload, the PHY header including one or more of an indication of the source address and the purpose or type of the message. In various embodiments, the ranging request message can include the scheduling message and the response can include a clear-to-send (CTS) message, and the time interval can include a short interframe space (SIFS).

In various embodiments, indicating the timing adjustment can include receiving a control or management frame identifying one or more wireless devices and including the timing adjustment for each of the one or more wireless devices. In various embodiments, the scheduling message can include an indication that the transmission of each of the plurality of wireless devices is to be started at a time based on a reference start time and on the timing adjustment for each of the plurality of wireless devices. In various embodiments, the reference start time can include a short interframe space (SIFS) time after reception of the scheduling message.

In various embodiments, the reference start time can include a point coordination function (PCF) interframe space (PIFS) time after reception of the scheduling message. In various embodiments, the reference start time can include a time agreed between at least one wireless device and access point. In various embodiments, the method can further include subtracting from the reference start time the timing adjustment. In various embodiments, receiving the scheduling message can include determining that the transmission of the wireless device is to be started at a time based on a reference start time and no timing adjustment.

In an embodiment, the method shown in FIG. 22 can be implemented in a wireless device that can include a determining circuit, a transmitting circuit, and a receiving circuit. Those skilled in the art will appreciate that a wireless device can have more components than the simplified wireless device described herein. The wireless device described herein includes only those components useful for describing some prominent features of implementations within the scope of the claims.

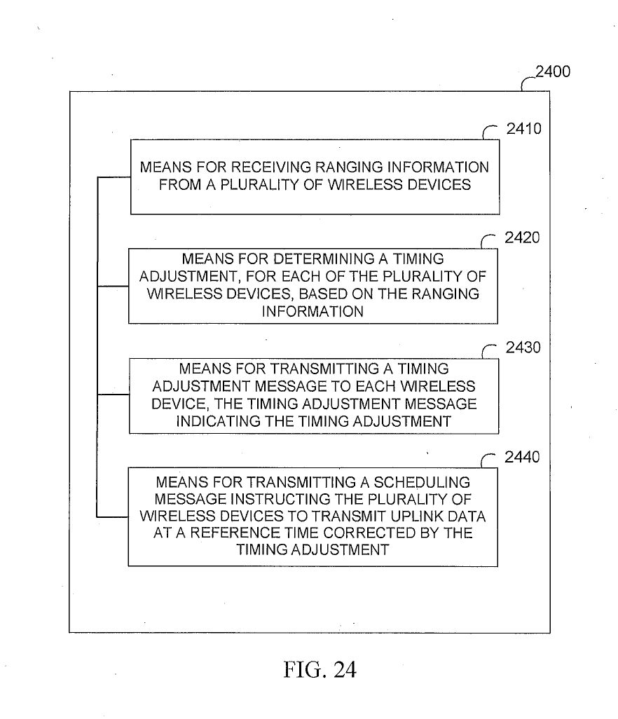

FIG. 24 is a functional block diagram of an apparatus 2400 for wireless communication. Those skilled in the art will appreciate that an apparatus for detecting wireless communication can have more components than the simplified AP 110 (FIG. 2) or the wireless device 302 (FIG. 3). The apparatus 2400 for wireless communication shown includes only those components useful for describing some prominent features of implementations within the scope of the claims. The apparatus 2400 for wireless communication includes means 2410 for receiving ranging information from a plurality of wireless devices, means 2420 for determining a timing adjustment, for each of the plurality of wireless devices, based on the ranging information, means 2430 for transmitting a timing adjustment message to each wireless device, the timing adjustment message indicating the timing adjustment, and means 2440 for transmitting a scheduling message instructing the plurality of wireless devices to transmit uplink data at a first reference time corrected by the timing adjustment. In various aspects, the apparatus 2400 can further include means for performing any other block or function described herein.

In an aspect, means 2410 for receiving ranging information can be configured to perform one or more of the functions described above with respect to block 2210 (FIG. 22). In various aspects, means 2410 can be implemented by one or more of the receiver 312 (FIG. 3), the transceiver 314 (FIG. 3), the processor 304 (FIG. 3), the DSP 320 (FIG. 3), the signal detector 318 (FIG. 3), and the memory 306 (FIG. 3). In some implementations, means for receiving can include the receiving circuit.

In an aspect, means 2420 for determining a timing adjustment can be configured to perform one or more of the functions described above with respect to block 2220 (FIG. 22). In various aspects, means 2420 can be implemented by one or more of the transmitter 310 (FIG. 3), the transceiver 314 (FIG. 3), the processor 304 (FIG. 3), the DSP 320 (FIG. 3), and the memory 306 (FIG. 3). In some implementations, means for determining can include the determining circuit.

In an aspect, means 2430 for transmitting a timing adjustment message can be configured to perform one or more of the functions described above with respect to block 2230 (FIG. 22). In various aspects, means 2430 can be implemented by one or more of the transmitter 310 (FIG. 3), the transceiver 314 (FIG. 3), the processor 304 (FIG. 3), the DSP 320 (FIG. 3), and the memory 306 (FIG. 3). In some implementations, means for transmitting a timing adjustment message can include the transmitting circuit.

In an aspect, means 2440 for transmitting a scheduling message can be configured to perform one or more of the functions described above with respect to block 2240 (FIG. 22). In various aspects, means 2440 can be implemented by one or more of the transmitter 310 (FIG. 3), the transceiver 314 (FIG. 3), the processor 304 (FIG. 3), the DSP 320 (FIG. 3), and the memory 306 (FIG. 3). In some implementations, means for transmitting a scheduling message can include the transmitting circuit.

In an embodiment, the method shown in FIG. 23 can be implemented in a wireless device that can include a transmitting circuit, and a receiving circuit. Those skilled in the art will appreciate that a wireless device can have more components than the simplified wireless device described herein. The wireless device described herein includes only those components useful for describing some prominent features of implementations within the scope of the claims.

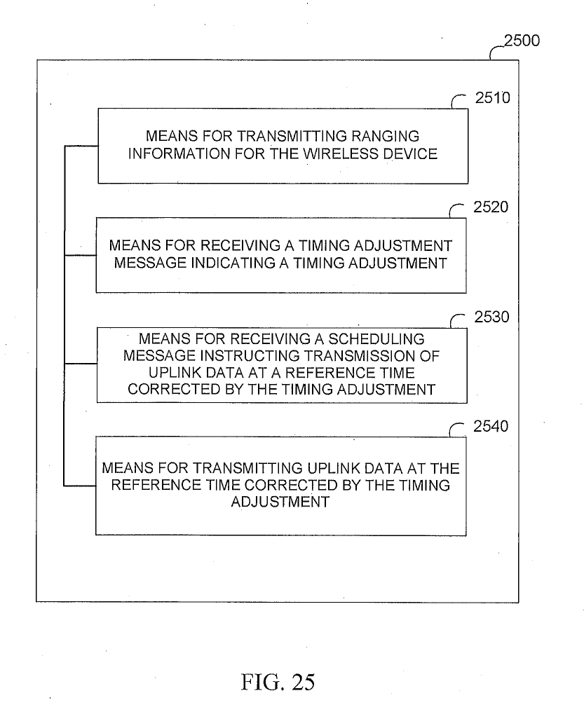

FIG. 25 is a functional block diagram of an apparatus 2500 for wireless communication. Those skilled in the art will appreciate that an apparatus for detecting wireless communication can have more components than the simplified AP 110 (FIG. 2) or the wireless device 302 (FIG. 3). The apparatus 2500 for wireless communication shown includes only those components useful for describing some prominent features of implementations within the scope of the claims. The apparatus 2500 for wireless communication includes means 2510 for transmitting ranging information from a plurality of wireless devices, means 2520 for receiving a timing adjustment, means 2530 for receiving a scheduling message, and means 2540 for transmitting uplink data. In various aspects, the apparatus 2500 can further include means for performing any other block or function described herein.

In an aspect, means 2510 for transmitting ranging information can be configured to perform one or more of the functions described above with respect to block 2310 (FIG. 23). In various aspects, means 2510 can be implemented by one or more of the transmitter 310 (FIG. 3), the transceiver 314 (FIG. 3), the processor 304 (FIG. 3), the DSP 320 (FIG. 3), and the memory 306 (FIG. 3). In some implementations, means for transmitting ranging information can include the transmitting circuit.

In an aspect, means 2520 for receiving a timing adjustment can be configured to perform one or more of the functions described above with respect to block 2310 (FIG. 23). In various aspects, means 2520 can be implemented by one or more of the receiver 312 (FIG. 3), the transceiver 314 (FIG. 3), the processor 304 (FIG. 3), the DSP 320 (FIG. 3), the signal detector 318 (FIG. 3), and the memory 306 (FIG. 3). In some implementations, means for receiving a timing adjustment can include the receiving circuit.

In an aspect, means 2530 for receiving a scheduling message can be configured to perform one or more of the functions described above with respect to block 2310 (FIG. 23). In various aspects, means 2530 can be implemented by one or more of the receiver 312 (FIG. 3), the transceiver 314 (FIG. 3), the processor 304 (FIG. 3), the DSP 320 (FIG. 3), the signal detector 318 (FIG. 3), and the memory 306 (FIG. 3). In some implementations, means for receiving a scheduling message can include the receiving circuit.

In an aspect, means 2540 for transmitting uplink data can be configured to perform one or more of the functions described above with respect to block 2330 (FIG. 23). In various aspects, means 2540 can be implemented by one or more of the transmitter 310 (FIG. 3), the transceiver 314 (FIG. 3), the processor 304 (FIG. 3), the DSP 320 (FIG. 3), and the memory 306 (FIG. 3). In some implementations, means for transmitting uplink data can include the transmitting circuit.

A person/one having ordinary skill in the art would understand that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

Various modifications to the implementations described in this disclosure can be readily apparent to those skilled in the art, and the generic principles defined herein can be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

The various operations of methods described above can be performed by any suitable means capable of performing the operations, such as various hardware and/or software component(s), circuits, and/or module(s). Generally, any operations illustrated in the Figures can be performed by corresponding functional means capable of performing the operations.

The various illustrative logical blocks, modules and circuits described in connection with the present disclosure can be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor can be a microprocessor, but in the alternative, the processor can be any commercially available processor, controller, microcontroller or state machine. A processor can also be implemented as a combination of computing devices, e.g., a combination of a DSP and a microprocessor, a plurality of microprocessors, one or more microprocessors in conjunction with a DSP core, or any other such configuration.

In one or more aspects, the functions described can be implemented in hardware, software, firmware, or any combination thereof. If implemented in software, the functions can be stored on or transmitted over as one or more instructions or code on a computer-readable medium. Computer-readable media includes both computer storage media and communication media including any medium that facilitates transfer of a computer program from one place to another. A storage media can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium can comprise non-transitory computer readable medium (e.g., tangible media). In addition, in some aspects computer readable medium can comprise transitory computer readable medium (e.g., a signal). Combinations of the above should also be included within the scope of computer-readable media.

The methods disclosed herein comprise one or more steps or actions for achieving the described method. The method steps and/or actions can be interchanged with one another without departing from the scope of the claims. In other words, unless a specific order of steps or actions is specified, the order and/or use of specific steps and/or actions can be modified without departing from the scope of the claims.

Further, it should be appreciated that modules and/or other appropriate means for performing the methods and techniques described herein can be downloaded and/or otherwise obtained by a STA and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a STA and/or base station can obtain the various methods upon coupling or providing the storage means to the device. Moreover, any other suitable technique for providing the methods and techniques described herein to a device can be utilized.

While the foregoing is directed to aspects of the present disclosure, other and further aspects of the disclosure can be devised without departing from the basic scope thereof, and the scope thereof is determined by the claims that follow.

What is claimed is:

1. A method for wireless communication, comprising:
receiving, at an access point, ranging information from a plurality of wireless devices;
determining a timing adjustment, for each of the plurality of wireless devices, based on the ranging information;
transmitting a timing adjustment message to each wireless device, the timing adjustment message indicating the timing adjustment; and
transmitting a scheduling message instructing the plurality of wireless devices to transmit uplink data at a first reference time corrected by the timing adjustment.

2. The method of claim 1, wherein the timing adjustment message and the scheduling message comprise the same message.

3. The method of claim 1, wherein receiving the ranging information comprises:
transmitting a ranging request message requesting a response from one or more of the plurality of wireless devices at a second reference time;
receiving at least one response at an offset time; and
measuring a time difference between the second reference time and the offset time.

4. The method of claim 3, wherein the second reference time comprises a time based on the transmission of the ranging request message.

5. The method of claim 3, wherein the reference time comprises a time occurring at a time interval after an end of transmission of the ranging request message.

6. The method of claim 5, wherein the time interval comprises a short interframe space (SIFS) or a point coordination function (PCF) interframe space (PIFS).

7. The method of claim 5, wherein the time interval is agreed between at least one wireless device and the access point.

8. The method of claim 3, wherein measuring the time comprises storing a measured time for each of one or more of the plurality of wireless devices.

9. An access point configured to provide wireless communication, comprising:
a receiver configured to receive ranging information from a plurality of wireless devices;
a processor configured to determine a timing adjustment, for each of the plurality of wireless devices, based on the ranging information; and
a transmitter configured to:
transmit a timing adjustment message to each wireless device, the timing adjustment message indicating the timing adjustment; and
transmit a scheduling message instructing the plurality of wireless devices to transmit uplink data at a first reference time corrected by the timing adjustment.

10. The access point of claim 9, wherein the processor is configured to determine the timing adjustment by calculating, for each of the plurality of wireless devices, a timing adjustment as a difference between a largest of timing measurements of the plurality of wireless devices and a timing measurement of each of the plurality of wireless devices.

11. The access point of claim 9, wherein the transmitter is configured to indicate the timing adjustment by transmitting a control or management frame identifying one or more of the plurality of wireless devices and including the timing adjustment for each of the one or more of the plurality of wireless devices.

12. The access point of claim 9, wherein the scheduling message comprises an indication that the transmission of each of the plurality of wireless devices is to be started at a time based on a reference start time and on the timing adjustment for each of the plurality of wireless devices.

13. The access point of claim 12, wherein the reference start time comprises a short interframe space (SIFS) time after reception of the scheduling message.

14. The access point of claim 12, wherein the reference start time comprises a point coordination function (PCF) interframe space (PIFS) time after reception of the scheduling message.

15. The access point of claim 12, wherein the reference start time comprises a time agreed between at least one wireless device and access point.

16. A method for wireless communication, comprising:
transmitting, at a wireless device, ranging information for the wireless device;
receiving, from an access point, a timing adjustment message indicating a timing adjustment;
receiving a scheduling message instructing transmission of uplink data at a first reference time corrected by the timing adjustment; and
transmitting uplink data at the reference time corrected by the timing adjustment.

17. The method of claim 16, wherein the timing adjustment message and the scheduling message comprise the same message.

18. The method of claim 16, wherein transmitting the ranging information comprises:
receiving a ranging request message requesting a response from the wireless device at a reference time; and
transmitting at least one response at an offset time.

19. The method of claim 18, wherein the second reference time comprises a time based on the transmission of the ranging request message.

20. The method of claim 18, wherein the reference time comprises a time occurring at a time interval after an end of transmission of the ranging request message.

21. The method of claim 20, wherein the time interval comprises a short interframe space (SIFS) or a point coordination function (PCF) interframe space (PIFS).

22. The method of claim 20, wherein the time interval is agreed between the wireless device and the access point.

23. A wireless device configured to provide wireless communication, comprising:
a transmitter configured to transmit ranging information for the wireless device; and
a receiver configured to:
receive, from an access point, a timing adjustment message indicating a timing adjustment; and
receive a scheduling message instructing transmission of uplink data at a first reference time corrected by the timing adjustment,
the transmitter further configured to transmit uplink data at the reference time corrected by the timing adjustment.

24. The wireless device of claim 23, wherein indicating the timing adjustment comprises receiving a control or management frame identifying one or more wireless devices and including the timing adjustment for each of the one or more wireless devices.

25. The wireless device of claim 23, wherein the scheduling message comprises an indication that the transmission of each of the plurality of wireless devices is to be started at a time based on a reference start time and on the timing adjustment for each of the plurality of wireless devices.

26. The wireless device of claim 25, wherein the reference start time comprises a short interframe space (SIFS) time after reception of the scheduling message.

27. The wireless device of claim 25, wherein the reference start time comprises a point coordination function (PCF) interframe space (PIFS) time after reception of the scheduling message.

28. The wireless device of claim 25, wherein the reference start time comprises a time agreed between at least one wireless device and access point.

29. The wireless device of claim 25, further comprising a processor configured to subtract from the reference start time the timing adjustment.

30. The wireless device of claim 23, further comprising a processor configured to determine that the transmission of the wireless device is to be started at a time based on a reference start time and no timing adjustment.
